(19) United States
(12) Patent Application Publication
(10) Pub. No.: US 2026/0289519 A1
(43) Pub. Date: Sep. 24, 2026

(54) SYSTEM

(71) Applicant: SoftBank Group Corp., Tokyo (JP)

(72) Inventor: Soshi KOYAMA, Tokyo (JP)

(73) Assignee: SoftBank Group Corp., Tokyo (JP)

(21) Appl. No.: 19/564,199

(22) Filed: Mar. 12, 2026

(30) Foreign Application Priority Data
Mar. 19, 2025 (JP) 2025-044548

(51) Int. Cl. G06Q 10/1093; G06Q 10/20

(52) U.S. Cl. CPC G06Q 10/1093; G06Q 10/20

(57) ABSTRACT

A system includes a processor that is configured to acquire schedule information from a user terminal, analyze the acquired schedule information to identify free time periods, and generate a prompt sentence for instructing a generative AI model to determine an optimal meeting date and time, based on a result of the analysis.

### CROSS-REFERENCE TO RELATED APPLICATION

This application is based on and claims priority under 35 USC 119 from Japanese Patent Application No. 2025-044548 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional meeting scheduling systems that rely on automatic calendar comparison generally determine candidate meeting times by simply detecting overlapping free time periods among participants. Such systems often require complex server-side logic or specialized optimization algorithms to compute an “optimal” meeting date and time, and they are not easily adaptable to changes in scheduling policies or user preferences. Furthermore, in many existing systems, it is difficult to flexibly incorporate various factors such as past meeting history, user priorities, and contextual constraints into the actual selection logic without substantial redevelopment of the scheduling engine. As a result, there is a problem in that development and maintenance costs are high, and the system cannot promptly respond to diverse scheduling requirements.

In addition, when generative AI models are used in scheduling, there is a problem that the input to the generative AI model is not structured or described in a way that fully reflects users'actual free time and constraints. If the prompt content is ambiguous or incomplete, the generative AI model may fail to select an appropriate meeting date and time, or may produce results that conflict with users'real availability. Accordingly, there is a need for a mechanism that can systematically obtain schedule information from user terminals, accurately identify free time periods, and then generate a prompt sentence suitable for instructing a generative AI model to determine an optimal meeting date and time in consideration of past meeting data and user priorities.

### SUMMARY

In order to solve the above-mentioned problems, an aspect of the present invention provides a system comprising a processor, wherein the processor is configured to acquire schedule information from a user terminal, analyze the acquired schedule information to identify free time periods, and generate a prompt sentence for instructing a generative AI model to determine an optimal meeting date and time, based on a result of the analysis. By structuring the schedule information received from user terminals and explicitly specifying free time periods, the processor enables the generative AI model to operate on clearly defined constraints, thereby improving the accuracy and reliability of the proposed meeting date and time.

In another aspect, the processor is configured to identify free time periods for each user, and input the identified free time periods to the generative AI model as a prompt sentence for instructing selection of the optimal meeting date and time. This makes it possible to represent, in the prompt, detailed availability conditions for multiple users, such that the generative AI model can take into account the collective free time of all participants when selecting the optimal meeting date and time.

In a further aspect, the processor is configured to cause the generative AI model, when selecting the optimal meeting date and time based on the prompt sentence, to adjust the date and time in consideration of past meeting data and priorities of users. By including, in the prompt sentence, information indicating historical meeting patterns, preference weights, or user priority levels, the generative AI model is guided to generate a meeting schedule that not only satisfies free time constraints but also reflects desired business rules and user-specific preferences. Consequently, the system can flexibly adapt to different scheduling policies without modifying core scheduling algorithms, thereby reducing development and maintenance burdens while achieving more appropriate and user-aligned meeting scheduling.

The term “system” refers to an arrangement of one or more hardware and software components that cooperate to execute the functions described in the claims.

The term “processor” refers to one or more hardware processing units, such as a CPU, GPU, or dedicated logic circuitry, and may further include associated memory and control logic configured to execute instructions for performing the claimed operations.

The term “user terminal” refers to any electronic device operated by a user, including but not limited to a personal computer, smartphone, tablet, or other network-enabled device, that is capable of transmitting schedule information to the system and receiving information from the system.

The term “schedule information” refers to data representing a user's planned activities and time allocations, including but not limited to calendar entries, appointments, events, and associated time periods, from which free time periods can be identified.

The term “free time periods” refers to time intervals within a user's or users'schedule during which no conflicting appointments, events, or reserved time slots are recorded in the schedule information.

The term “analyze” refers to processing data according to predetermined rules and algorithms, including parsing, comparing, filtering, or otherwise computing derived information, in order to obtain results such as identification of free time periods.

The term “prompt sentence” refers to a text or structured natural language string, or an equivalent machine-readable representation, that is generated for input to a generative AI model in order to specify instructions, constraints, and contextual information for determining an output.

The term “generative AI model” refers to a machine learning model, such as a large language model or other generative model, that is configured to generate text or other content in response to an input prompt, and that is used in the present invention to select an optimal meeting date and time.

The term “optimal meeting date and time” refers to a date and time, or a date-time interval, for a meeting that satisfies at least the free time constraints identified from the schedule information, and that is determined by the generative AI model in accordance with criteria specified in the prompt sentence, including at least one of past meeting data and user priorities.

The term “past meeting data” refers to information relating to meetings that have occurred previously, including but not limited to meeting dates and times, durations, participants, attendance records, and user feedback, which can be used to influence the selection of future meeting dates and times.

The term “user priorities” refers to preference information associated with one or more users, including but not limited to importance levels, ranking of users, preferred time zones, preferred meeting times, or weighting factors, that are used to adjust selection of the meeting date and time in favor of certain users or conditions.

The term “input to the generative AI model” refers to providing the prompt sentence, and optionally associated structured data, to the generative AI model through an application programming interface or equivalent communication mechanism so that the model can process the input and generate an output.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

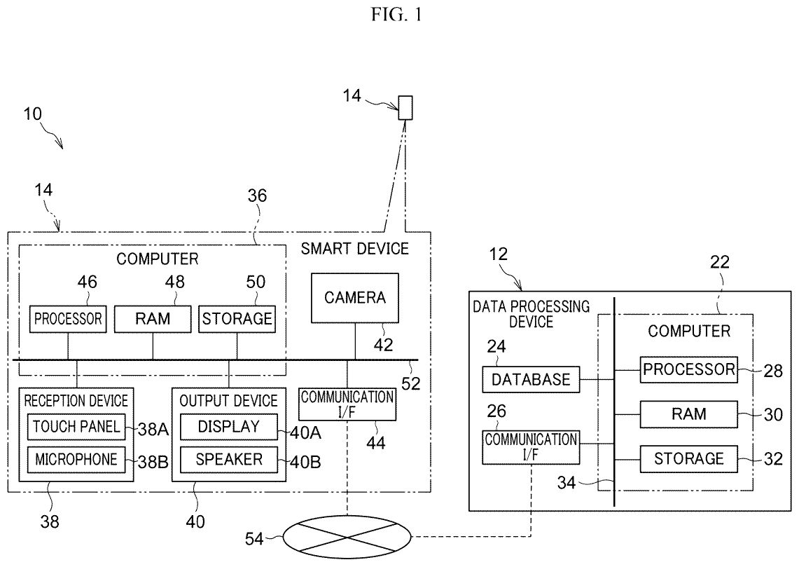

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

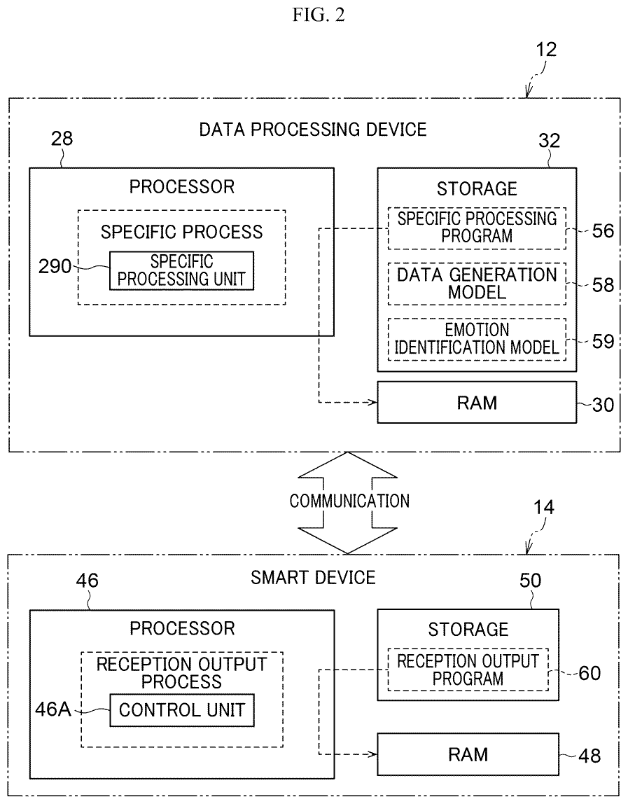

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional schedule coordination systems typically rely on rule-based algorithms that directly search calendar data to identify possible meeting times. Such systems suffer from several technical limitations in terms of computational efficiency, scalability, and flexibility of constraint handling. First, when the number of users and events increases, the system must repeatedly traverse heterogeneous calendar data structures, leading to increased processing time and memory usage, and making real-time scheduling difficult. Second, conventional systems generally encode constraints such as preferred time zones, working hours, and user-specific preferences as fixed rules, which are hard to maintain and extend, and which do not adapt well to changing usage patterns. Third, known systems do not effectively leverage generative AI models; when such models are used, calendar data is often passed in unstructured or ad hoc text form, causing ambiguity in interpretation, difficulty in verification, and a risk that the generated meeting time does not actually match the underlying availability.

Furthermore, in many existing architectures, there is no systematic mechanism to verify that a time proposed by an AI system truly lies within computed common free time intervals across all participants. As a result, the system may propose infeasible or suboptimal meeting times, thereby forcing additional manual adjustment and reducing the usefulness of automated scheduling. In addition, conventional approaches do not provide a structured way to use historical meeting behavior and user preference information in combination with generative AI models, so that the system cannot technically optimize meeting selection based on past patterns while still guaranteeing consistency with the computed availability.

Accordingly, there is a need for an improved computer-implemented scheduling technique that (i) transforms heterogeneous schedule-related information into a normalized, structured, and computationally tractable representation, (ii) computes and narrows common free time intervals by means of numerical and tabular operations, (iii) constructs precise prompt sentences that systematically encode both availability data and constraints for a generative AI model, and (iv) programmatically verifies AI-generated candidate meeting times against the precomputed common free time intervals. Such a technique should reduce computational overhead, enhance the reliability and accuracy of AI-assisted scheduling, and improve the overall functioning of the computer system performing the scheduling operation.

The specific processing by the specific processing unit 290 of the data processing device 12 in Example 1 is realized by the following means.

The present invention provides a server comprising a processor configured to acquire schedule-related information from external information processing apparatuses via a communication network and store the acquired schedule-related information as time information data, convert the schedule-related information into tabular data by means of time-series data processing software, calculate occupied time intervals for each usage entity, computationally specify free time intervals for each usage entity by excluding the occupied time intervals from a predetermined operation time range, and computationally extract common free time intervals among a plurality of usage entities, generate structured information including the common free time intervals and condition information, convert the structured information into a natural language description, and generate a prompt sentence including an instruction for a generative AI model to perform selection processing of candidate meeting dates and times and including an instruction defining an output format of the generative AI model, input the prompt sentence to the generative AI model, acquire a candidate meeting date and time output from the generative AI model, verify whether the candidate meeting date and time is included in the common free time intervals to thereby confirm the candidate meeting date and time, and generate meeting information based on the confirmed candidate meeting date and time, transmit the meeting information as notification information to terminals, and, in response to responses from the terminals, cause the external information processing apparatuses to execute schedule registration processes. This enables the server to normalize and pre-compute availability using efficient numerical and tabular operations, to precisely convey such availability and constraints to a generative AI model through a structured prompt sentence, and to automatically validate AI-generated candidate meeting times against the precomputed common free time intervals, thereby improving the technical performance, reliability, and scalability of computer-based scheduling operations.

The term “system” refers to an integrated arrangement of hardware and software components that cooperate to perform schedule coordination processing as described in the claims.

The term “processor” refers to one or more hardware computation units, such as a central processing unit or a processing core, configured to execute instructions that implement the schedule-related acquisition, transformation, analysis, and interaction with a generative AI model.

The term “server” refers to an information processing apparatus including at least the processor, memory, communication interfaces, and storage, configured to provide schedule coordination functions over a communication network to one or more terminals.

The term “communication network” refers to a wired or wireless data transmission infrastructure, such as a local area network, a wide area network, or a packet-switched public network, through which the server and external devices exchange information.

The term “external information processing apparatus” refers to a computer system or service that stores or manages schedule-related information and that is accessible from the server via the communication network.

The term “terminal” refers to a user-operated electronic device, such as a personal computer, smartphone, or tablet, configured to send schedule-related requests to the server and to receive notification information from the server.

The term “user” refers to a human operator or an organization that utilizes the terminal and the server to perform schedule coordination.

The term “usage entity” refers to a unit for which schedule availability is determined, including, for example, an individual user, a group of users, or a resource such as a room or equipment.

The term “schedule-related information” refers to data representing temporal allocations of activities, including start times, end times, event descriptions, and associated participants, which is used to determine occupied or free time intervals.

The term “time information data” refers to digital data representing temporal values, such as timestamps or time ranges, that are associated with schedule-related information.

The term “time-series data processing software” refers to a software component or library configured to process data indexed by time, and to transform schedule-related information into a tabular or structured format suitable for time-based computation.

The term “tabular data” refers to data organized in rows and columns, such as records with fields for start time, end time, and usage entity identifiers, that allows efficient computational operations on schedule-related information.

The term “occupied time interval” refers to a period of time during which a usage entity is scheduled for one or more events, such that the usage entity is not available for a new meeting.

The term “free time interval” refers to a period of time during which a usage entity is not scheduled for any event within a predetermined operation time range, and is therefore considered available for scheduling.

The term “common free time interval” refers to a time interval that is included in the free time intervals of a plurality of usage entities, and thus represents a candidate period during which those usage entities can jointly attend a meeting.

The term “predetermined operation time range” refers to a predefined temporal range, such as working hours for a given day, within which the system determines availability for scheduling.

The term “condition information” refers to constraint data related to scheduling, including, for example, desired meeting duration, preferred time zones, preferred time slots, and exclusion periods.

The term “structured information” refers to machine-readable data that encodes common free time intervals and condition information in a formalized format, such as key-value pairs, lists, or tables.

The term “natural language description” refers to a representation of structured information expressed in a human language, in whole or in part, that can be included in a prompt sentence for a generative AI model.

The term “prompt sentence” refers to a natural language instruction sequence provided as input to a generative AI model, the instruction sequence specifying at least schedule-related constraints, availability information, and an output format to guide the model's processing.

The term “generative AI model” refers to a trained machine learning model that generates text or structured data outputs based on input prompts, and that is configured to select or evaluate candidate meeting dates and times according to constraints encoded in a prompt sentence.

The term “output format” refers to a specified structural pattern for the output of the generative AI model, such as a particular arrangement of fields, data types, or syntactic delimiters, which facilitates parsing and validation by the server.

The term “candidate meeting date and time” refers to a proposed date and time range for holding a meeting, generated or evaluated by the generative AI model based on availability and constraints.

The term “verification” refers to a computational process in which the server checks whether a candidate meeting date and time lies within one of the common free time intervals and satisfies specified condition information.

The term “meeting information” refers to data describing a planned meeting, including at least a confirmed date, time, duration, and participants, and optionally location or communication links.

The term “notification information” refers to message content transmitted from the server to a terminal, informing the user of proposed or confirmed meeting information and optionally requesting a response.

The term “schedule registration process” refers to an operation where a schedule entry corresponding to confirmed meeting information is created, modified, or stored in a calendar or schedule management system of an external information processing apparatus.

The term “numerical calculation software” refers to a software component or library configured to perform arithmetic and logical operations on numerical data, such as arrays or sequences representing time values, for the purpose of computing and narrowing candidate time intervals.

The term “numerical sequence” refers to an ordered set of numerical values representing time-related data, such as discrete timestamps or encoded time intervals.

The term “set operation” refers to a mathematical operation, such as intersection, union, or difference, performed on sets of numerical values representing time-related data to derive candidate time intervals.

The term “interval operation” refers to a computation applied to time ranges, such as determining overlaps, gaps, or containment relationships between intervals, to derive common or candidate time intervals.

The term “predetermined meeting duration” refers to a specified length of time required for a meeting, used as a criterion for filtering candidate time intervals.

The term “past meeting history information” refers to stored data describing previously scheduled meetings, including their times, participants, and related attributes, used to influence subsequent scheduling decisions.

The term “preference information” refers to data indicating desired or undesired scheduling characteristics for each usage entity, such as favored time periods, days of week, or meeting frequency.

The term “time-slot priority information” refers to data indicating relative preference levels among different time periods, used by the system and the generative AI model to evaluate and rank candidate meeting dates and times.

The term “reason information” refers to explanatory data output by the generative AI model that describes the rationale or basis for selecting a particular candidate meeting date and time.

The term “final meeting date and time” refers to a specific date and time interval that has been selected from among multiple candidate meeting dates and times, and that is used for actual schedule registration in a calendar system.

In one embodiment, a server functions as a schedule coordination apparatus that cooperates with one or more terminals used by users. The server includes at least one processor, a main memory, a non-volatile storage device, and a network interface. The processor is, for example, a general-purpose central processing unit (CPU) installed in a physical or virtual machine. The memory stores executable instructions and data structures implementing the schedule coordination functions. The network interface provides connectivity to external information processing apparatuses, such as calendar management services, over a communication network using standard protocols such as HTTPS and REST.

The server uses an operating system such as a general-purpose server operating system, and uses a runtime environment such as a general-purpose scripting language interpreter. The server further uses software libraries for time-series data processing, for example a tabular data processing library, and numerical calculation libraries for array-based computation. The server may also use a database management system to persist schedule-related information, user preference information, and meeting history information. The server communicates with a generative AI model implemented as a neural network model, which is provided either as a remote AI service accessible via an API endpoint or as a locally deployed inference engine.

The server acquires schedule-related information from external information processing apparatuses that manage calendar data for multiple users. The server uses an authentication protocol, for example an authorization framework, to obtain access tokens for each user. The server transmits calendar query requests containing parameters such as user identifiers, time ranges, and time zones. The external apparatuses return schedule-related information in a structured format such as a hierarchical text-based data format. The server stores these responses in memory as raw time information data.

The server converts the schedule-related information into tabular data using time-series data processing software. The server creates a structured table in which each record includes fields such as a usage entity identifier, a start time, an end time, and an event category. The server normalizes all time values to a common reference time zone and converts them to internal timestamp representations, for example integer values indicating elapsed time units from a fixed epoch. By using such uniform representations, the server can apply efficient vectorized operations when computing occupied and free intervals.

The server calculates occupied time intervals for each usage entity by interpreting each event record as an interval [start, end). The server aggregates intervals with overlapping or adjacent boundaries and merges them into minimal non-overlapping occupied intervals. The server stores the occupied intervals as numerical sequences, in which each interval is represented by a pair of numeric values. The server defines a predetermined operation time range for each day, for example 09:00 to 18:00 in local time, and converts this range into numeric values in the same time representation.

The server computationally specifies free time intervals for each usage entity by subtracting the occupied intervals from the predetermined operation time range. The server performs interval operations by computing the gaps between adjacent occupied intervals within the operation range. For example, if the operation range is [Tstart, Tend) and occupied intervals are [A1, B1), [A2, B2), the server calculates free intervals such as [Tstart, A1), [B1, A2), and [B2, Tend), subject to boundary conditions and minimum duration constraints. The server stores the free intervals in another table that includes fields for usage entity identifier, free interval start, free interval end, and free interval duration.

The server computes common free time intervals among multiple usage entities by representing each free interval as a pair of numerical values and then performing set operations or interval intersection operations on these numerical sequences. For a candidate time grid, the server transforms intervals into binary occupancy vectors and uses logical operations to locate contiguous positions where all relevant usage entities are simultaneously available. Alternatively, the server performs interval intersection recursively across entities by maintaining a current set of intersection intervals and updating this set when each new user's free intervals are processed. The server filters out intervals whose durations are shorter than a predetermined meeting duration, leaving only candidate intervals that satisfy the length requirement.

The server generates structured information that includes the common free time intervals and condition information such as required meeting duration, user-specified date range, preferred time zones, preferred days of week, and exclusion intervals (for example lunch breaks). The structured information is stored in a data structure such as an object with named fields, or as a list of candidate intervals with associated metadata. The server converts the structured information into a natural language description suitable for use as part of a prompt sentence. In this conversion, the server transforms numeric timestamps into human-readable dates and times and composes text descriptions such as “Candidate slot 1: Tuesday 3:00 PM to 4:00 PM (all participants available).”

The server constructs a prompt sentence for the generative AI model by combining the user's original request, the computed candidate intervals, and explicit instructions about the desired output format. The server assembles a continuous text string including the constraints and conditions. For example, the server generates a prompt sentence such as: “The user wants to schedule a 1-hour meeting between next Monday and Friday for the following participants: [Participant A], [Participant B], [Participant C]. The following candidate time slots are available for all participants (in local time): (1) Next Tuesday from 9:00 to 10:00, (2) Next Tuesday from 15:00 to 16:00, (3) Next Wednesday from 13:00 to 14:00. Participants prefer meeting times between 9:00 and 17:00 and wish to avoid lunch breaks between 12:00 and 13:00. Please choose the single best time slot for all participants and return the result in the following format: date: YYYY-MM-DD, start_time: HH:MM, end_time: HH:MM, reason: short explanation of why this time is optimal.”

The server structures the prompt sentence so that it encodes both availability and constraints in a deterministic and machine-parsable form. This structure reduces ambiguity in the interpretation by the generative AI model and facilitates downstream parsing of the model's output by the server.

In one embodiment, the generative AI model is implemented as a transformer-based neural network including an embedding layer, multiple attention blocks, and a feed-forward output layer. The model is initially trained using a corpus of scheduling-related text and structured schedule annotations. The training uses supervised learning where input prompt-like texts are paired with target outputs indicating preferred time slots and textual explanations. The model uses a loss function such as a cross-entropy loss measuring the difference between predicted output token distributions and target sequences. The model updates trainable weights using a gradient-based optimization method such as stochastic gradient descent with adaptive learning rates. During training, the system may apply data augmentation techniques such as random perturbation of time ranges, shuffling of candidate slots, and variation of natural language phrasing, in order to improve robustness to prompt variation.

The server, when using the generative AI model at inference time, sets parameters such as decoding temperature, maximum output length, and stop sequences to guide the output format. The server requests that the model produce outputs containing explicit date and time values and a reason string that explains the selection. Internally, the model processes the prompt tokens through attention mechanisms that weigh different parts of the input, including user constraints and candidate slots, to formulate output tokens that correspond to a selected candidate interval.

The server receives the output text from the generative AI model and parses it to extract the date, start time, end time, and reason. The server converts the extracted date and time back into internal timestamp representations and verifies that this interval exactly matches one of the precomputed common free time intervals. This verification step distinguishes the present system from approaches that rely solely on the generative AI model's free-form output, because the server treats the model's output as a candidate suggestion that must be checked against a rigorously computed availability set. If the proposed time does not correspond to any common free time interval, the server either rejects the suggestion and requests a revised output by issuing an updated prompt sentence that includes an error description, or falls back to a deterministic selection algorithm based purely on the precomputed candidate intervals.

The server generates meeting information including the confirmed meeting date and time, the participants, and optionally a communication link for an online conference generated via integration with an external conferencing service. The server formats notification information as message content suitable for delivery to terminals using communication channels such as email protocols or push notification services. The server sends this notification to each relevant terminal, associating the notification with a unique scheduling session identifier.

The terminal receives the notification and displays the meeting information to the user using a graphical user interface. The terminal shows the proposed date, time, participants, and the explanation (reason) provided by the generative AI model. The user can approve or reject the proposal through UI controls. The terminal sends the user's response to the server. The server aggregates responses and, upon confirmation, sends schedule registration requests to external information processing apparatuses to create calendar entries corresponding to the confirmed meeting.

By converting schedule-related information into normalized tabular and numerical representations, and by computing common free time intervals using interval operations and numerical sequences, the server reduces the computational complexity compared to naive event-by-event scanning at each scheduling attempt. The reuse of precomputed common free intervals enables the server to handle multiple candidate evaluations and constraint modifications without re-querying and re-computing the entire schedule. This improves processing speed and reduces communication load with external information processing apparatuses.

By structuring the prompt sentence with explicit candidate intervals and constraints, the server reduces the search space that the generative AI model must explore. The generative AI model is not required to infer raw availability from full event histories; instead, it focuses on ranking and choosing among already valid candidates according to nuanced preferences and history-based patterns. This separation of concerns results in improved accuracy and stability of suggested meeting times. The server's verification and correction loop further reduces errors, because any inconsistency between the model's textual suggestion and the computed availability is detected and remedied.

In another embodiment, the server includes a preference learning module that maintains time-slot priority information for each usage entity. The server constructs feature vectors for candidate intervals, including features such as day of week, local hour of day, historical acceptance rate for similar times, and proximity to prior meetings. The server periodically updates these priority weights by applying machine learning techniques such as logistic regression or gradient-boosted decision trees using past meeting outcomes (accepted or rejected) as labels. The server combines these priority scores with the selection performed by the generative AI model by either embedding the priority information in the prompt sentence or applying a post-processing re-ranking of AI-suggested candidates. This hybrid approach yields meeting times that not only satisfy availability but also align with learned user preferences in a data-driven manner.

In a further embodiment, the server supports alternative algorithmic variations for computing common free intervals. For example, the server may discretize time into fixed-length slots, represent user availability as bit arrays, and perform bitwise logical operations to compute common free regions. This representation allows highly efficient operations on large sets of users and long time ranges, improving scalability. The same system architecture can flexibly switch between continuous interval methods and discrete-slot methods depending on the required resolution and performance constraints.

The server provides technical effects that go beyond merely automating human mental steps. The explicit interval representation and numerical operations optimize the internal data management of schedule information, reducing memory fragmentation and improving cache locality when operating on contiguous numeric arrays. The structured prompt generation and verification mechanisms convert the generative AI model into a tightly constrained component whose outputs can be reliably integrated into deterministic computing pipelines. This configuration enhances the reliability and predictability of the overall system, reduces erroneous scheduling, and lowers the need for manual corrections.

The server, by coupling precomputation of common free intervals with a generative AI model that selects among constrained candidates and produces explicit reasons, improves both computational efficiency and decision transparency. The generative AI model is not used as a generic text generator but as a specialized selection engine whose inputs and outputs are systematically structured. This design yields improved processing speed (due to reduced input complexity to the model), improved accuracy (due to post-verification against precomputed intervals), and reduced communication load (due to minimized re-querying of external calendar systems).

Various modifications of the above embodiments are possible. The server may run on a single physical machine or on a distributed cluster where different modules, such as the calendar acquisition module, the interval computation module, the prompt generation module, and the AI interaction module, are deployed as separate services. The generative AI model may be replaced or complemented by other learning-based models, such as recurrent neural networks or hybrid rule-based and neural architectures, provided that the prompt sentence mechanism and structured output verification are preserved. The time-series data processing and numerical computation may be implemented using different software libraries or custom-optimized code, as long as occupied and free intervals are represented as explicit data structures enabling efficient interval operations.

The terminal may take various forms, including desktop applications, web-based interfaces, and mobile applications. The user may provide initial scheduling constraints in different ways, such as selecting from UI elements or entering free-text requirements that the server parses using natural language understanding components. Regardless of the user interface variation, the server performs the core technical operations described above, thereby ensuring that the inventive concept remains centered on improved computer processing of schedule information rather than on particular business rules or front-end designs.

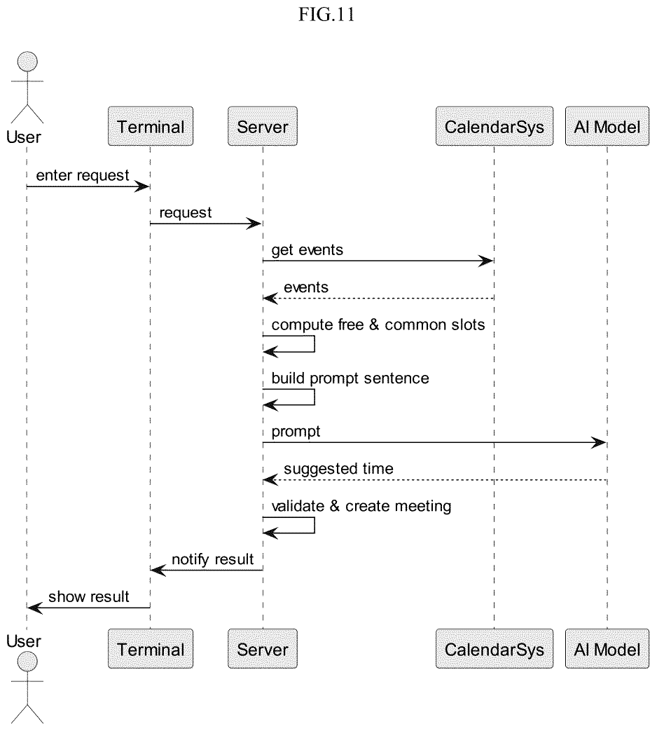

The following describes the processing flow using FIG. 11.
Step 1:

The user specifies scheduling requirements.

The user inputs a natural-language request on the terminal, such as a desired date range, meeting duration, and participant list.

Input: A free-text request (for example, “I want to schedule a 1-hour meeting between next Monday and Friday for the project team.”).

Output: A formatted request message sent from the terminal to the server over a network.

The terminal encapsulates the user's text and metadata (user ID, language, time zone) into a request object and transmits it via HTTPS to the server.
Step 2:

The server parses the user request and extracts constraints.

Input: The formatted request message received from the terminal.

Output: Structured constraint data including date range, required duration, and participant identifiers.

The server uses a text parsing module or natural-language understanding component to identify key entities (dates, times, duration, and names) in the free-text request and converts them into normalized fields, such as a start date, an end date, a numeric duration in minutes, and a list of participant accounts. The server stores the extracted constraints in memory associated with a scheduling session identifier.
Step 3:

The server acquires schedule-related information from external information processing apparatuses.

Input: Structured constraint data and participant identifiers.

Output: Raw schedule-related information for each participant, represented as structured data (for example, lists of events in a text-based hierarchical format).

The server uses an authentication token repository to retrieve authorization credentials for each participant. The server then sends API requests to external calendar management systems, specifying the participant identifier and the target time window (for example, next Monday to next Friday). The external systems return event data that includes start time, end time, and event attributes. The server stores this data in memory or a temporary data store as time information data.
Step 4:

The server normalizes schedule-related information and converts it to tabular data.

Input: Raw schedule-related information from multiple external systems.

Output: One or more tables in which each record represents a single event with normalized time fields.

The server converts all time strings into internal timestamp representations using a common reference time zone. The server then uses time-series data processing software to construct tabular data structures where each row includes a usage entity identifier, a start timestamp, an end timestamp, and an event category code. The server resolves differences in formats among external systems by mapping their fields into a unified schema. This normalization allows subsequent time computations to be performed as numeric operations.
Step 5:

The server computes occupied time intervals for each usage entity.

Input: Tabular event data containing start and end timestamps per usage entity.

Output: A set of non-overlapping occupied intervals for each usage entity, represented as ordered pairs of numeric values.

The server sorts events for each usage entity by start timestamp, then scans through the list to merge overlapping or adjacent events. When two events overlap or touch, the server creates a merged interval spanning from the earliest start to the latest end. The server stores these merged intervals in a separate table or array where each row consists of a usage entity identifier, an occupied interval start timestamp, and an occupied interval end timestamp.
Step 6:

The server determines operation time ranges and calculates free time intervals per usage entity.

Input: Occupied intervals per usage entity and configuration data specifying operation time ranges.

Output: Free time intervals per usage entity within the operation time ranges.

The server generates operation time ranges (for example, 09:00 to 18:00 local time for each day in the specified date range) and converts them to internal timestamps. For each usage entity and each day, the server subtracts the occupied intervals from the operation range by computing the gaps between intervals. Where the operation range is [Tstart, Tend) and occupied intervals are [A1, B1), [A2, B2), the server calculates free intervals, such as [Tstart, A1), [B1, A2), and [B2, Tend), while discarding any interval whose length is zero or negative. The server records the result in a free-interval table containing usage entity identifiers, free interval start and end timestamps, and computed durations.
Step 7:

The server computes common free time intervals among all relevant usage entities.

Input: Free time intervals per usage entity and required meeting duration.

Output: A set of candidate common free intervals that satisfy the duration requirement.

The server represents each user's free intervals as numerical sequences or interval lists and employs numerical calculation software to perform intersection operations. For example, the server maps intervals to a timeline and uses set intersection to find ranges where all participants are simultaneously free. Alternatively, the server discretizes time into fixed slots and uses logical AND on bit arrays representing availability. The server filters out any intersection interval whose duration is shorter than the requested meeting duration and stores the remaining intervals as candidate common free time intervals.
Step 8:

The server generates structured information including candidate intervals and condition information.

Input: Candidate common free time intervals and constraint data (date range, duration, preferences).

Output: Structured information object containing candidate intervals and scheduling conditions.

The server creates a data structure that includes a list of candidate intervals (each with start, end, and duration) and metadata such as preferred time windows, excluded intervals, and user-specific preferences. The server assigns identifiers to each candidate interval, which will later be referenced in natural-language descriptions. This structured information forms the basis for constructing a precise prompt sentence.
Step 9:

The server converts structured information into a natural language description of candidate intervals.

Input: Structured information object.

Output: A textual description of candidate intervals and constraints.

The server formats each candidate interval by converting its timestamps to human-readable dates and times in the appropriate time zone. For each interval, the server generates text such as “Candidate slot 1: Tuesday from 9:00 to 10:00 (all participants available).” The server concatenates these descriptions together with textual expressions of the constraints, such as “Participants prefer times between 9:00 and 17:00 and avoid lunch breaks between 12:00 and 13:00.” The result is a coherent description that can be embedded inside a prompt sentence.
Step 10:

The server constructs a prompt sentence for a generative AI model.

Input: The user's original request, the textual description of candidate intervals, and instructions about desired output format.

Output: A prompt sentence suitable for input to the generative AI model.

The server assembles a single text sequence that includes: (i) a summary of the user's goal, (ii) the enumerated candidate intervals, (iii) expressed preferences and constraints, and (iv) explicit instructions describing the required output fields and format. For example, the server constructs a prompt sentence such as: “The user wants to schedule a 1-hour meeting between next Monday and Friday for the following participants: [Participant A], [Participant B], [Participant C]. The following candidate time slots are available for all participants (in local time): (1) Next Tuesday from 9:00 to 10:00, (2) Next Tuesday from 15:00 to 16:00, (3) Next Wednesday from 13:00 to 14:00. Participants prefer meeting times between 9:00 and 17:00 and wish to avoid lunch breaks between 12:00 and 13:00. Please choose the single best time slot for all participants and return the result in the following format: date: YYYY-MM-DD, start_time: HH: MM, end_time: HH: MM, reason: short explanation of why this time is optimal.”
Step 11:

The server sends the prompt sentence to the generative AI model and obtains an output.

Input: The prompt sentence produced in Step 10.

Output: A textual response including a proposed date, start time, end time, and reason.

The server transmits the prompt sentence to the generative AI model via an AI inference API. The server sets parameters such as maximum token length and temperature to enforce deterministic behavior and concise output. The generative AI model processes the prompt and returns a text response, for example:
“date: 2026-02-03, start_time: 15:00, end_time: 16:00, reason: All participants are available, and this time avoids lunch breaks and early-morning hours.”

The server receives this response and stores it temporarily for validation.
Step 12:

The server parses and validates the AI-generated candidate meeting date and time.

Input: The textual response from the generative AI model and the precomputed candidate common free intervals.

Output: A confirmed meeting date and time or an indication that the AI suggestion is invalid.

The server extracts the date, start time, end time, and reason from the AI's text response by pattern matching or structured parsing. The server converts the date and time into internal timestamp values and checks whether this interval matches one of the candidate common free intervals computed in Step 7. If the interval is found and the duration equals the required duration, the server marks the suggestion as valid and confirmed. If the interval does not match, the server either formulates a revised prompt sentence that reports the inconsistency or selects a default candidate interval using deterministic ranking rules.
Step 13:

The server generates meeting information based on the confirmed meeting date and time.

Input: The confirmed interval (date, start time, end time) and participant list.

Output: A meeting information object containing all details required for schedule registration and notification.

The server creates a structured object that includes the meeting title, the confirmed start and end timestamps, the list of participants, and optional attributes such as a virtual meeting link or physical location. The server may request the creation of a conferencing session from an external conferencing system and include the returned link in the meeting information.
Step 14:

The server sends notification information to terminals and receives user responses.

Input: Meeting information object.

Output: Notification messages dispatched to terminals, and response data received from terminals.

The server formats human-readable notification messages containing the confirmed date and time and the explanatory reason. The server sends emails or push notification payloads to each participant's terminal via appropriate communication services. Each notification includes actionable elements (for example, “Accept” and “Decline” options). The terminal receives the notification, displays the content to the user, and, when the user selects an option, sends the decision back to the server as response data.
Step 15:

The server performs schedule registration in external information processing apparatuses.

Input: Meeting information and aggregated user responses.

Output: One or more calendar entries created or updated in external systems and a final confirmation sent to terminals.

The server determines whether sufficient users have accepted the proposed meeting time according to predefined rules (for example, all required participants must accept). Upon confirmation, the server sends schedule creation requests to external calendar systems, specifying the start time, end time, title, and participants. The external systems register the meeting as calendar events. The server then transmits final confirmation notifications to the terminals, informing the users that the meeting has been successfully scheduled and registered.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional computerized maintenance management systems are typically configured to statically register maintenance intervals and to generate schedules by applying fixed rules to calendar data. Such systems generally treat sensor data, operation logs, and user calendars as separate data sources and do not dynamically integrate them in real time. As a result, these systems are unable to automatically generate maintenance schedules that adapt to changing operation states of apparatuses, evolving maintenance histories, or complex resource constraints reflected in user schedules.

In particular, existing systems often rely on simple threshold checks or periodic timers executed by a processor. Although such logic can detect that an apparatus has exceeded a predefined operating time, it cannot efficiently coordinate maintenance timing across a plurality of apparatuses while considering actual downtime risk, human resource availability, and interaction between different apparatuses. In many implementations, when a conflict between a proposed maintenance time and an existing event arises, the adjustment is performed manually by an operator, which introduces latency and inconsistency and increases processor load due to repeated recalculation and manual overrides.

Furthermore, while generative AI models have recently been applied to natural language tasks, conventional maintenance scheduling systems do not utilize prompt sentences as structured instructions that combine operation information, maintenance history information, and schedule constraints. As a consequence, the generative AI model, if used at all, is not tightly integrated into the scheduling pipeline of the processor, and cannot systematically improve its estimation accuracy based on feedback from finalized maintenance decisions. The inability to close this feedback loop results in underutilization of computational resources devoted to model inference and training, and prevents the system from achieving higher-quality schedules over time.

In addition, known approaches that merely call a machine learning model as a black box do not clearly define, at the processor level, how to construct inputs, detect temporal conflicts with existing schedules, and adjust the model's proposal in a deterministic and traceable manner. This makes it difficult to guarantee predictable behavior and to scale the system to large numbers of apparatuses and users without degrading responsiveness or increasing the risk of overlapping downtimes.

Accordingly, there is a need for an improved computer-implemented technique in which a processor systematically acquires operation information and schedule information, constructs and supplies a prompt sentence and associated feature data to a generative AI model, receives a proposed optimal execution date and time for maintenance work, automatically detects and resolves temporal conflicts with existing schedule information, and outputs adjusted execution dates and times in a format suitable for visual display. There is also a need for the processor to provide learning information, including past maintenance results and past adjusted execution dates and times, back to the generative AI model so that the overall computer system can iteratively improve scheduling accuracy and efficiency, thereby enhancing the technical performance of the maintenance scheduling functionality itself.

The specific processing by the specific processing unit 290 of the data processing device 12 in Application Example 1 is realized by the following means.

The present invention provides a server comprising a processor configured to acquire operation information regarding a plurality of target apparatuses, analyze the acquired operation information and maintenance history information to specify operation states of the target apparatuses, calculate candidate time periods for maintenance work of the target apparatuses on the basis of the specified operation states and schedule information acquired by the processor, generate a prompt sentence that instructs a generative AI model to select an optimal execution date and time for the maintenance work on the basis of the calculated candidate time periods and the operation information and the maintenance history information, input the prompt sentence to the generative AI model, compare a proposal result of the optimal execution date and time for the maintenance work output from the generative AI model with the schedule information to detect a temporal conflict, adjust the optimal execution date and time in accordance with the detected temporal conflict, convert the adjusted execution date and time for the maintenance work into information for visual display, and output the information for visual display to a terminal. This enables the computer system to technically improve maintenance scheduling by integrating sensor-derived operation information, historical maintenance information, and calendar-based schedule constraints into a unified processing pipeline, to automatically generate and refine optimal maintenance execution dates and times through interaction with a generative AI model using explicit prompt sentences, to systematically resolve temporal conflicts at the processor level without relying on manual adjustments, and to iteratively enhance the model's estimation accuracy and system responsiveness through feedback of past proposal results and adjusted schedules.

The term “operation information” refers to information indicating an operating state of an apparatus, including, for example, runtime, cycle count, sensor measurements, fault codes, or other data representing usage conditions over time.

The term “maintenance history information” refers to information indicating past maintenance activities performed on an apparatus, including dates, types of work, replacement parts, durations, and any recorded causes or results of such activities.

The term “target apparatus” refers to a physical device or equipment subject to operation monitoring and maintenance scheduling, including, for example, production machinery, industrial robots, or other operational equipment.

The term “schedule information” refers to information indicating planned events over time, including, for example, operation schedules of target apparatuses, work schedules of users, and other time-based reservations or constraints.

The term “candidate time period” refers to a time interval computed by the processor as a potential window during which maintenance work on a target apparatus may be executed, prior to conflict checking and final adjustment.

The term “maintenance work” refers to an activity performed to inspect, repair, service, or otherwise maintain a target apparatus, including both preventive and corrective maintenance operations.

The term “execution date and time” refers to a specific point in time or time interval allocated for performing maintenance work on a target apparatus, including a start time and an end time.

The term “prompt sentence” refers to a sequence of natural language characters or tokens generated by the processor to instruct a generative AI model regarding a task, including constraints and objectives for selecting an optimal execution date and time for maintenance work.

The term “generative AI model” refers to an information processing model configured to generate output data, such as proposed execution dates and times, based on input data including a prompt sentence and optionally numerical features, and implemented, for example, by a machine learning or deep learning architecture.

The term “proposal result” refers to information output by the generative AI model indicating a proposed optimal execution date and time for maintenance work, optionally including associated confidence values or priorities.

The term “temporal conflict” refers to a condition in which a proposed execution date and time for maintenance work overlaps or is otherwise incompatible with existing schedule information, such as overlapping operation schedules or user commitments.

The term “information for visual display” refers to structured data generated by the processor and formatted for presentation on a display device, including, for example, calendar entries, timeline segments, or graphical indicators representing maintenance schedules.

The term “terminal” refers to an information processing apparatus used by a user to display and interact with schedule information, including, for example, a client computer, a portable communication device, or a tablet device.

The term “past maintenance result information” refers to information indicating outcomes of completed maintenance work, including whether a failure was prevented or resolved, actual downtime experienced, and any deviations from planned execution dates and times.

The term “past adjusted execution date and time information” refers to information indicating execution dates and times for maintenance work that were modified from initially proposed schedules, including the reasons or context for such adjustments.

The term “learning information” refers to a collection of data provided to the generative AI model for training or updating model parameters, including operation information, maintenance history information, past maintenance result information, and past adjusted execution date and time information.

The term “operation schedule information” refers to schedule information specifically indicating planned operation or non-operation of target apparatuses, including planned production runs, shutdowns, and previously scheduled maintenance activities.

The term “work schedule information” refers to schedule information indicating planned work-related activities of users, including working hours, meetings, shifts, and other time-based commitments relevant to maintenance planning.

The term “maximum number of target apparatuses to be stopped simultaneously” refers to a constraint specifying an upper limit on how many target apparatuses may be placed in a non-operating state in a same time period for maintenance or other purposes.

The term “simultaneous stop prohibition condition” refers to a constraint indicating that specific combinations of target apparatuses must not be in a non-operating state at the same time, for example, to avoid disrupting a production process or compromising system redundancy.

In an embodiment, a server manages maintenance scheduling for a plurality of target apparatuses installed in a facility. The server includes one or more processors, a storage device, a memory, and a communication interface. The server runs an operating system such as a server-type operating system, and application software including an interpreter or runtime environment for a high-level programming language (for example, a Python environment), a database management system, and a machine learning framework (for example, a tensor-based computation framework). The server communicates with a plurality of terminals via a network such as an Internet Protocol network or an industrial communication network.

The server acquires operation information regarding each target apparatus from sensors and controllers connected to the target apparatuses. The server uses hardware interfaces such as network interface cards and fieldbus adapters to receive sensor signals including temperature, vibration, current, cycle count, and error codes. The server stores the received operation information in a structured format in the database management system, for example as relational tables with fields representing apparatus identifiers, timestamps, sensor types, and numerical values. The server also stores maintenance history information, such as past maintenance dates, work categories, and failure types, in dedicated tables linked to each apparatus identifier.

The server analyzes the stored operation information and maintenance history information by executing numerical processing code in the high-level programming environment. The server loads operation records into matrix-like data structures and performs statistical processing, including calculation of moving averages, variance, and outlier detection based on thresholds of standardized scores. The server converts irregularly sampled sensor readings into fixed-interval time series by resampling and interpolation. The server calculates derived features, such as cumulative operating hours since last maintenance, frequency of fault occurrences in a sliding time window, and gradients of temperature or vibration over time. By computing these features, the server specifies operation states of the target apparatuses, for example by classifying them into categories such as “normal,” “degraded,” or “high-risk,” based on numeric criteria.

The server acquires schedule information that includes operation schedule information of the target apparatuses and work schedule information of users. The server obtains such schedule information from external calendar services or internal scheduling databases via an application programming interface. The schedule information is normalized into internal data structures comprising event identifiers, start and end timestamps, associated apparatus identifiers, and user identifiers. The server indexes this schedule information by time and by apparatus to support efficient conflict detection.

The server calculates candidate time periods for maintenance work for each target apparatus by combining the specified operation states and the schedule information. The server executes an algorithm that searches within a future time horizon and identifies time intervals where the predicted risk based on operation states exceeds a threshold and where the apparatus is not scheduled for critical operation. The server uses internal data structures representing time slots, such as arrays of discrete time steps with flags indicating availability and risk scores. The server thus marks candidate time periods as intervals where both availability and risk criteria are satisfied.

The server generates a prompt sentence as natural language text to instruct a generative AI model. The server constructs the prompt sentence by inserting apparatus identifiers, summary statistics of operation information, summary statistics of maintenance history information, and constraints extracted from schedule information into a sentence template. An example of such a prompt sentence is:
“Based on the operating data and maintenance history of each machine, and considering existing production events from the calendar, propose an optimized maintenance schedule for the next 30 days that minimizes total downtime and avoids schedule conflicts.”

In another example, for a specific apparatus, the server generates the following prompt sentence:
“Using the last 30 days of operating data and maintenance history for Robot A, and considering that Robot A must not stop during Monday morning production batches recorded in the calendar, generate an optimized maintenance window within the next 14 days that minimizes overload risk and avoids production conflicts.”

The server converts the prompt sentence into input suitable for the generative AI model. In one embodiment, the server uses a tokenizer to convert the prompt sentence into a sequence of token identifiers, which are further converted into embedding vectors. The server also converts the numerical features representing operation states, derived statistics, and candidate time periods into tensor arrays. The server concatenates or otherwise combines these tensor arrays with the embeddings of the prompt sentence, forming a unified input tensor.

The server executes the generative AI model using a machine learning framework. In one embodiment, the generative AI model is implemented as a neural network architecture that includes an encoder-decoder structure with attention mechanisms. The encoder receives the embedding sequence of the prompt sentence and the numerical feature tensors, and the decoder outputs a sequence representing proposed maintenance windows, where each output element corresponds to a start time offset, a duration, and a priority level. The server configures layers such as fully connected layers, recurrent layers, and attention layers with predetermined numbers of units and activation functions. During inference, the server initializes the decoder state and iteratively computes output tokens using the attention weights over encoded representations of the prompt and feature inputs.

The server determines proposal results in the form of proposed execution dates and times for maintenance work on each target apparatus by decoding the output sequence of the generative AI model. The server maps discrete output indices to actual timestamps using the time grid used in the candidate time period calculation. The server thus obtains, for each apparatus, one or more proposed maintenance windows along with confidence scores derived from softmax probability distributions at the output layer.

The server compares the proposal results with the schedule information to detect temporal conflicts. The server performs interval overlap checks between each proposed maintenance window and scheduled events in the calendar for the corresponding apparatus and related apparatuses. The server also checks user work schedule information to avoid assigning maintenance windows during times when required personnel are unavailable. The server uses algorithms with sorted time intervals and sweep-line or segment-tree methods to efficiently detect overlaps in large-scale deployment. When the server detects a temporal conflict, the server adjusts the optimal execution date and time by shifting or expanding candidate intervals according to predefined adjustment rules.

The server applies non-conventional rules for adjustment that differ from manual practices. For example, the server may enforce a constraint that no more than a specified number of target apparatuses can be in a maintenance state simultaneously in a given time slot. The server incorporates such constraints by maintaining a count of concurrently proposed maintenance operations and, when the count exceeds the threshold, automatically shifting the least critical maintenance windows based on risk and priority scores. The server may further enforce simultaneous stop prohibition conditions between particular apparatuses, such as apparatuses that form a critical production pair, by programmatically disallowing overlapping windows and searching for alternative slots. This automated adjustment procedure is performed according to algorithmic rules implemented in the server code, which reduces the need for repeated manual conflict checking.

The server converts the adjusted execution dates and times for maintenance work into information for visual display. The server generates structured display data, for example, a list of event objects represented as records containing fields for apparatus identifiers, start and end times, maintenance types, and risk indicators. The server may also compute color codes or icons based on priority and risk levels. The server transmits this structured display data to terminals via an application programming interface, typically using a structured data format.

The terminal receives the structured display data from the server and renders it on a display device. The terminal runs a web browser or a dedicated application that interprets the structured data and draws graphical elements such as calendar entries, timeline bars, or tabular lists. The terminal allows user interaction, for example, selection of a maintenance entry to view detailed information, or adjustment of a proposed execution time by dragging graphical elements along a timeline. The terminal sends any modifications made by the user back to the server.

The user views the scheduling information on the terminal and may choose to modify specific maintenance windows. When the user changes an execution date or time, the user triggers an update operation on the terminal. The terminal encodes the new parameters and sends them to the server, which then validates the changes against the schedule information and updates the database accordingly. The server can log both the original proposal and the user-adjusted schedule as part of past maintenance result information and past adjusted execution date and time information.

The server periodically uses the accumulated operation information, maintenance history information, past maintenance result information, and past adjusted execution date and time information as learning information to train or fine-tune the generative AI model. The server executes a training routine in which the model parameters are optimized according to a loss function that quantifies the difference between the model's proposed schedules and the final accepted maintenance schedules. For example, the server may define a loss function that combines a cross-entropy component for predicting correct time slot classes and a penalty term for violating constraints such as maximum concurrent maintenance operations. The server performs backpropagation through the neural network to compute gradients of the loss with respect to model weights and updates the weights using an optimization algorithm such as stochastic gradient descent or adaptive moment estimation. The server may also perform data augmentation by perturbing historical schedules within allowable bounds to increase training sample diversity.

By structuring both inference and training in this way, the server improves the technical performance of the scheduling process. The server reduces the number of required recomputations by caching intermediate features and by reusing encoded representations of operation information across multiple scheduling tasks. The server reduces communication load between the server and terminals by transmitting compact structured display data instead of raw sensor logs. The server improves accuracy by explicitly incorporating conflict constraints and past adjustment behavior into the training process, thereby enabling the generative AI model to produce proposals that are closer to final acceptable schedules. The server improves processing speed by utilizing vectorized operations in the machine learning framework and by organizing time-based data into contiguous arrays that can be processed efficiently by the processor cache hierarchy.

The server thus does not merely automate a human scheduling activity. Instead, the server implements a specific data pipeline in which operation information, maintenance history information, and schedule information are normalized into particular data structures; in which a prompt sentence is constructed with embedded numeric summaries and constraints; in which a neural network architecture processes both linguistic and numeric inputs; and in which deterministic conflict detection and adjustment algorithms enforce non-trivial constraints. This combination of structured input generation, specialized generative AI model usage, and algorithmic conflict resolution yields an improvement in the way the computer system processes and manages maintenance scheduling data, leading to lower error rates, more efficient use of computing resources, and reduced downtime of apparatuses.

In a variation of the embodiment, the generative AI model may be implemented as a transformer-based model with multiple encoder layers and decoder layers. The server in such a variation encodes the prompt sentence and the numerical features separately and then fuses them using cross-attention mechanisms. In another variation, the server uses a hybrid model where a recurrent layer processes time series features of operation information, and a separate language model processes the prompt sentence, and the outputs of both models are concatenated and fed into a decision layer that outputs maintenance windows. The server can also adapt the loss function to include terms that penalize schedules causing high predicted failure probability or excessive simultaneous apparatus downtime.

In another embodiment, the server may operate in an environment where the target apparatuses are mobile or distributed devices. The server still acquires operation information via a network, performs the same types of feature extraction and schedule optimization, and provides adjusted schedules to terminals operated by maintenance personnel. In yet another embodiment, a terminal may implement a subset of the above-described processing, such as local visualization or local caching of schedules, while the core generative AI model and conflict resolution logic remain centralized on the server.

Through these embodiments and variations, the server, the terminal, and the user interact in a coordinated manner such that the generative AI model is integrated into a concrete, technically detailed workflow that improves the underlying computer-based scheduling mechanism and not merely the presentation of schedule information to human operators.

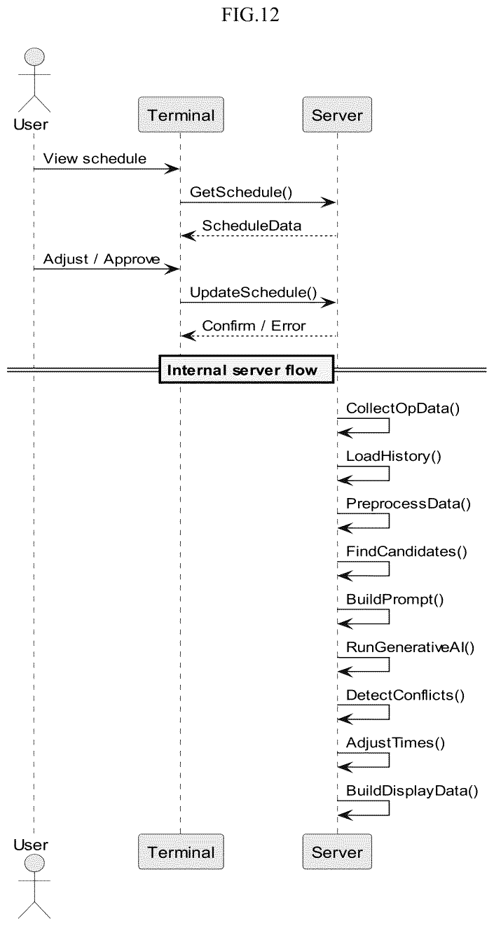

The following describes the processing flow using FIG. 12.
Step 1:

Server acquires raw operation information from target apparatuses.

Server receives, as input, sensor readings and status logs transmitted from controllers of the apparatuses, including timestamps, apparatus identifiers, operating time, cycle counts, temperatures, vibrations, and error codes.

Server writes the input data into a database as records in tables that include fields for apparatus ID, timestamp, sensor type, and numeric value. Server performs basic validation, such as discarding records with missing apparatus IDs or invalid timestamps, and outputs stored operation information organized by apparatus and time.
Step 2:

Server acquires maintenance history information and schedule information.

Server receives, as input, existing maintenance logs stored in the database and calendar data obtained from an external scheduling service or an internal scheduling module. The maintenance history includes past maintenance dates, types of work, and results, and the schedule information includes planned operation events and user work events with start and end times.

Server normalizes these inputs by converting times to a common time zone, mapping external identifiers to internal apparatus IDs and user IDs, and storing the normalized records in structured tables. Server outputs consolidated maintenance history information and schedule information linked to each apparatus.
Step 3:

Server preprocesses operation information and maintenance history information to derive operation states.

Server receives, as input, the stored operation information and maintenance history information for each apparatus over a target period.

Server loads the input into in-memory data structures, groups records by apparatus, and performs data cleaning such as interpolating missing sensor values and removing outliers using statistical thresholds. Server computes derived metrics, including cumulative operation hours since last maintenance, fault frequency in recent windows, and trend indicators such as moving averages and slopes of temperature or vibration. Server compares these metrics with predefined numeric thresholds and categorization rules to assign an operation state label (for example, normal, warning, or high-risk) to each apparatus. Server outputs operation state information and feature vectors representing the derived metrics per apparatus.
Step 4:

Server computes candidate time periods for maintenance work.

Server receives, as input, the operation state information, the feature vectors, and the schedule information for a future time horizon.

Server creates a time grid that divides the future horizon into discrete time slots. For each apparatus, server evaluates each time slot by checking whether the apparatus is scheduled for critical operation and whether the predicted risk (derived from the feature vectors and operation state) is above a target threshold within that slot. Server sets availability flags for slots that are not reserved by operation events and calculates a risk score for each slot. Server then combines availability flags and risk scores to select contiguous intervals that satisfy both criteria as candidate time periods for maintenance. Server outputs, for each apparatus, a list of candidate time periods with associated scores.
Step 5:

Server generates a prompt sentence for a generative AI model.

Server receives, as input, the candidate time periods, the summarized feature vectors for operation information and maintenance history information, and schedule constraints such as maximum allowed simultaneous maintenance operations.

Server constructs textual summaries of apparatus conditions, such as “Apparatus X has accumulated N operating hours since last maintenance and has Y recent faults,” and incorporates these summaries and schedule constraints into a natural language template. Server concatenates the textual elements into a coherent prompt sentence that instructs the generative AI model on the optimization objective and constraints. For example, server may generate the prompt sentence:
“Based on the operating data and maintenance history of each machine, and considering existing production events from the calendar, propose an optimized maintenance schedule for the next 30 days that minimizes total downtime and avoids schedule conflicts.”

Server outputs the resulting prompt sentence as text for use as part of the model input.
Step 6:

Server constructs model input data structures and executes the generative AI model.

Server receives, as input, the prompt sentence generated in Step 5 and the numerical feature vectors and candidate time periods from Steps 3 and 4.

Server tokenizes the prompt sentence into tokens, converts the tokens to integer IDs, and applies an embedding layer to obtain dense vector representations. Server also arranges the numerical feature vectors and representations of candidate time periods into tensor arrays with fixed dimensions. Server feeds the embedded prompt tokens and the numeric tensors into an encoder-decoder type neural network implemented in a machine learning framework, in which encoder layers process the combined sequences and decoder layers generate output tokens representing a maintenance schedule. The generative AI model internally performs matrix multiplications, attention weight computations, and nonlinear activations to map the input tensors to output tensors. Server decodes the output tensors into human-readable schedule proposals, each including an apparatus ID, a proposed start time offset, a proposed duration, and a priority score. Server outputs a set of proposed execution dates and times for maintenance work for each apparatus.
Step 7:

Server detects temporal conflicts between proposed execution dates and times and existing schedule information.

Server receives, as input, the proposed execution dates and times from Step 6 and the schedule information from Step 2.

Server converts the proposed execution dates and times into absolute timestamps by adding offsets to the start of the scheduling horizon and creates interval objects representing each maintenance window. Server then compares these intervals against existing schedule intervals for operations and user commitments using an overlap detection algorithm that sorts intervals by start time and scans through them to find conflicts. For each conflict, server records which apparatus and which events are overlapping, and calculates the degree of conflict, such as overlapping duration. Server outputs conflict annotations that associate each proposed maintenance window with zero or more conflicting events.
Step 8:

Server adjusts proposed execution dates and times according to conflict information and system constraints.

Server receives, as input, the proposed execution dates and times and the conflict annotations from Step 7, as well as constraint parameters such as the maximum number of apparatuses allowed to be stopped simultaneously and simultaneous stop prohibition conditions for specific apparatus pairs.

Server iteratively examines each proposed maintenance window. When a conflict is detected or a constraint is violated, server shifts or resizes the window according to predetermined rules: for example, server searches for the nearest neighboring time slot where the apparatus is available and the count of simultaneously maintained apparatuses is below the threshold, and where no prohibited pair would be stopped together. Server uses the risk scores from candidate time periods to prefer slots with higher risk reduction potential. Server recomputes overlap and constraint satisfaction for each adjusted window and repeats adjustment if necessary until a consistent schedule is found or the search limit is reached. Server outputs adjusted execution dates and times that satisfy temporal and constraint conditions, along with updated priority and risk attributes.
Step 9:

Server converts adjusted execution dates and times into information for visual display and provides it to the terminal.

Server receives, as input, the adjusted execution dates and times and associated attributes such as apparatus identifiers, maintenance types, and risk levels from Step 8.

Server generates display-oriented data structures, such as lists of event records containing fields for title, start time, end time, apparatus name, and color code derived from priority or risk. Server may also aggregate events by day or by apparatus and create summary indicators such as total planned downtime per day. Server serializes these structures into a format suitable for transmission and sends them via a network interface to the terminal in response to a display request. Server outputs visual display information that is ready for rendering by the terminal.
Step 10:

Terminal renders schedule information and accepts user input for review and modification.

Terminal receives, as input, the visual display information from Step 9.

Terminal parses the structured event records and maps them to graphical components such as calendar entries, charts, or lists. Terminal draws these components on a display device, aligning each maintenance window with the appropriate time scale and apparatus label. Terminal enables interaction operations, for example, the user can tap an event to open a detailed view showing operation and maintenance history summaries, or drag an event to another time to propose a schedule change. Terminal captures such user interactions and converts them into updated schedule parameters, such as new start and end times or modified priority flags. Terminal outputs updated schedule modification requests to the server.
Step 11:

User reviews proposed schedules and optionally modifies them.

User receives, as input, the rendered maintenance schedule on the terminal display.

User examines the timing, apparatus assignment, and risk indications of the proposed maintenance windows and determines whether they align with real-world constraints such as staffing, material availability, and safety considerations. User may approve certain proposals without change or may select specific events and move them to alternative time slots on the terminal's interface. User may also input textual comments describing reasons for changes, such as “shifted due to operator training.” User thereby generates modified schedules which the terminal forwards to the server.
Step 12:

Server validates user modifications and finalizes maintenance schedules.

Server receives, as input, the updated schedule modification requests from the terminal and the previously adjusted execution dates and times.

Server checks each requested modification against the same constraints applied in Step 8, including overlap with existing events, maximum concurrent maintenance limits, and simultaneous stop prohibition rules. If a modification satisfies all constraints, server updates the corresponding records in the database, marking them as confirmed maintenance windows. If a modification violates constraints, server may reject the change and generate an error message or propose alternative nearby slots using the same adjustment algorithm as in Step 8. Server outputs finalized maintenance schedules and, optionally, error or confirmation messages.
Step 13:

Server records execution outcomes and prepares learning information for future model training.

Server receives, as input, the finalized maintenance schedules from Step 12 and, after actual execution of maintenance work, outcome information such as actual start and end times, downtime duration, and whether failures were prevented or resolved.

Server stores the final schedules and outcomes as past maintenance result information and past adjusted execution date and time information in the database. Server constructs training samples by pairing original model proposals with the final accepted schedules and associated context features. Server aggregates these samples and formats them as training datasets with input tensors (operation features, history features, schedule constraints) and target outputs (final schedule time slots). Server outputs learning information ready to be used in an offline training process to update parameters of the generative AI model.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional meeting scheduling and notification systems require human operators to manually analyze participants' schedules, determine suitable meeting times, and compose notification messages. This manual workflow is time-consuming, error-prone, and does not scale well when the number of participants, meetings, or constraints increases. Some existing systems provide basic calendar aggregation or rule-based time slot suggestion, but such systems typically treat schedule analysis, meeting time selection, and message generation as separate processes, and do not leverage generative AI models in an integrated manner. As a result, these systems often fail to efficiently compute an optimal meeting time that accounts for complex constraints, and cannot automatically generate natural language notifications that accurately reflect the selected time and meeting context.

From a computer-technology standpoint, existing approaches do not provide an optimized server-side control flow for constructing prompt sentences, invoking a generative AI model, and feeding back the model outputs into subsequent communication processing. In particular, they do not define how a processor should systematically (i) transform heterogeneous schedule data into constraint-aware prompt sentences, (ii) orchestrate multiple invocations of a generative AI model for both meeting time selection and natural language message generation, and (iii) manage transmission result information as structured status data that can be programmatically consumed by user terminals. This leads to inefficiencies in processing pipelines, increased network round trips, inconsistent data representations, and difficulty in reliably tracking and presenting delivery status.

Furthermore, in conventional systems, past meeting data and user priority information are not effectively integrated into the computational workflow for meeting time optimization and notification generation. Even when such data are available, they are often processed by ad hoc business logic on the application side, rather than being encoded in structured prompt sentences that guide a generative AI model. This limits the system's ability to adaptively optimize meeting times and message content based on historical patterns, user preferences, and priority relationships, and thus constrains the improvement of the overall system performance and user experience.

Accordingly, there is a need for a computer-implemented system that improves the way a processor acquires meeting information, constructs and applies prompt sentences, interacts with a generative AI model, generates natural language notifications, and records and exposes transmission result information. Such a system should provide a technically improved processing architecture that reduces manual intervention, enhances the efficiency and reliability of meeting scheduling and notification, and optimizes the utilization of network and computation resources in a server-based environment.

The specific processing by the specific processing unit 290 of the data processing device 12 in Example 2 is realized by the following means.

The present invention provides a server comprising a processor configured to acquire meeting information, including schedule information of at least one participant, from a user terminal; to analyze the acquired meeting information to identify available time periods of the at least one participant and, based on the available time periods, to specify at least one candidate meeting time; to generate a first prompt sentence based on the meeting information and the at least one candidate meeting time for instructing a generative AI model to select an optimal meeting time; to input the first prompt sentence into the generative AI model and acquire the optimal meeting time selected by the generative AI model; to generate a second prompt sentence based on the optimal meeting time and the meeting information for causing the generative AI model to generate a natural language notification message to be provided to meeting participants; to input the second prompt sentence into the generative AI model and acquire the natural language notification message generated by the generative AI model; to transmit the natural language notification message to the meeting participants via a communication unit; and to acquire and record transmission result information regarding transmission of the natural language notification message to the meeting participants and provide the transmission result information to the user terminal. This enables an integrated and technically improved server-side processing pipeline in which schedule data are algorithmically transformed into constraint-aware prompt sentences, a generative AI model is systematically utilized both for optimal meeting time selection and for natural language notification generation, and transmission result information is maintained as structured status data, thereby reducing manual operations, improving computational efficiency and reliability in meeting scheduling and notification, and enhancing the overall performance of the computer system.

The term “processor” refers to a hardware computation unit or a combination of hardware and software components that executes machine-readable instructions to perform data processing operations, including acquisition, analysis, generation, transmission, and recording of information as described herein.

The term “user terminal” refers to an information processing device, such as a personal computer, a smartphone, a tablet, or another computing apparatus, that is operated by a user to input meeting information, to receive transmission result information, and to communicate with the server over a communication network.

The term “meeting information” refers to information related to an event involving two or more participants, including at least schedule information, such as date and time, and optionally including agenda information, location information, and participant information.

The term “schedule information” refers to time-related data associated with at least one participant, including existing appointments, reserved time slots, and available time periods, which are used to determine candidate meeting times and an optimal meeting time.

The term “available time period” refers to a time interval during which a participant does not have conflicting schedule information and is regarded as being free to attend a meeting according to the analysis performed by the processor.

The term “candidate meeting time” refers to a proposed date and time or time interval for scheduling a meeting, which is derived from the available time periods of one or more participants before final selection of an optimal meeting time.

The term “optimal meeting time” refers to a selected date and time or time interval for a meeting that satisfies one or more constraints, such as availability of participants, and that is determined based on output from a generative AI model in response to a prompt sentence.

The term “prompt sentence” refers to a text string or sequence of tokens that encodes an instruction, condition, or context for a generative AI model, and that is generated by the processor based on meeting information, candidate meeting times, or optimal meeting times.

The term “first prompt sentence” refers to a prompt sentence generated by the processor based on meeting information and at least one candidate meeting time, and used to instruct a generative AI model to select an optimal meeting time.

The term “second prompt sentence” refers to a prompt sentence generated by the processor based on an optimal meeting time and meeting information, and used to cause a generative AI model to generate a natural language notification message to be provided to meeting participants.

The term “generative AI model” refers to a trained artificial intelligence model, such as a language model, that generates output data, including natural language text, in response to an input prompt sentence, and that is used to select an optimal meeting time and to generate notification messages.

The term “natural language notification message” refers to a text message expressed in a human language, automatically generated by a generative AI model, that describes at least the optimal meeting time and notifies one or more participants of details of a meeting.

The term “meeting participant” refers to an individual or entity that is intended to attend or receive information about a meeting and that is associated with contact information used by the system for transmitting the natural language notification message.

The term “communication unit” refers to a hardware or software component, or a combination thereof, that enables data transmission between the server and external devices or services, including transmission of the natural language notification message to meeting participants via a network.

The term “transmission result information” refers to information indicating a result of an attempt to transmit the natural language notification message to one or more meeting participants, including at least a success or failure status and optionally error details and timestamps.

In one embodiment, a server, a terminal, and a communication network cooperatively implement the claimed system. The server comprises at least one processor, a memory, a non-transitory storage medium, and a communication interface. The terminal comprises a processor, a display, an input unit such as a touch panel or keyboard, a memory, and a communication interface. The user operates the terminal to provide meeting information and to confirm transmission result information, while the server executes the core scheduling and notification processing.

The terminal provides a graphical user interface implemented, for example, as a web application executed by a general-purpose browser or as a native application executed by a mobile operating system. The terminal stores user input temporarily in local memory as structured data including at least a date-time string, an agenda string, and one or more participant descriptors. The terminal converts the user input into a structured data object, such as a key-value representation, and transmits the structured data to the server via the communication interface using a secure transport protocol such as HTTPS. The terminal thereby offloads computationally intensive analysis and generative processing to the server.

The server receives the structured data over the communication interface and stores it in main memory. The server uses a general-purpose operating system executing on a processor architecture such as an instruction set processor to manage processes responsible for meeting analysis and notification generation. The server parses the received structured data using a parsing module that converts the serialized representation into an internal in-memory data structure, for example, a tree or object graph comprising fields for schedule information, participant information, and optional metadata. The server normalizes the schedule information, such as by converting human-readable date-time strings into a standardized timestamp representation and by mapping participant identifiers to canonical participant records stored in a storage unit such as a relational database or a key-value store.

The server analyzes the normalized schedule information to identify available time periods of at least one participant. The server uses an availability computation module that retrieves existing appointments or reserved time slots for each participant from a schedule storage area, merges overlapping intervals, and subtracts these intervals from a configurable working-time domain. The server thereby generates, for each participant, a list of available time intervals represented as timestamp ranges. The server aggregates the lists for multiple participants to derive combined available intervals that satisfy multi-participant constraints, such as requiring that at least a subset or all participants be simultaneously available.

The server uses the derived available intervals to specify one or more candidate meeting times. The server applies an algorithm that samples each available interval at a configured granularity, such as 15-minute units, and that filters out candidate times that do not satisfy additional constraints such as minimum meeting duration, maximum meeting duration, or time-of-day restrictions. The server represents each candidate meeting time as a data record including a start time, an end time, and a set of participants. The server ranks the candidate meeting times by applying a scoring function that may incorporate factors such as the number of participants available, distribution of time zones, and historical attendance patterns, and selects a subset as candidate meeting times to be provided to a generative AI model.

The server generates a first prompt sentence by embedding the selected candidate meeting times and associated constraints into a text template stored in the memory. The server concatenates fixed instruction phrases with dynamically generated content derived from the data structures representing the candidate meeting times. For example, the server generates a first prompt sentence such as: “Please select the most suitable meeting time from the following candidate time slots, taking into account that all listed participants should be able to attend. Candidate time slots: (1) Oct. 15, 2023, 3:00 PM-4:00 PM; (2) Oct. 15, 2023, 4:00 PM-5:00 PM; (3) Oct. 16, 2023, 10:00 AM-11:00 AM. Participants: A, B, C. Return one optimal meeting time and briefly justify the selection.”

The server passes the first prompt sentence to a generative AI model implemented as a neural network. In one example, the generative AI model is a transformer-based language model stored on a storage device and loaded into memory at runtime. The generative AI model comprises an embedding layer that converts input tokens into vector representations, multiple self-attention layers that compute context-aware representations, feed-forward layers that transform the context vectors, and an output layer that maps internal representations to token probabilities. The server tokenizes the first prompt sentence into discrete tokens, converts them into embeddings, and feeds them into the model. The model executes a forward pass using matrix multiplications, attention weight computations, and non-linear activation functions such as rectified linear units or Gaussian error linear units. The server obtains output token probabilities and selects an output sequence corresponding to the model's proposed optimal meeting time and optional justification.

The server decodes the generated token sequence into a text string and parses the text to extract the optimal meeting time. The server applies rule-based extraction and, optionally, pattern matching using regular expressions to detect date and time expressions. The server validates the extracted optimal meeting time against the previously computed candidate intervals to ensure consistency. If the output falls outside acceptable ranges, the server applies a correction policy, such as re-querying the model with additional constraints or mapping the output to the closest valid candidate interval. By constraining the model's output and verifying it against structured data, the server reduces the risk of inconsistent or invalid meeting times and thereby improves the reliability of the system beyond simple human-like text generation.

The server then generates a second prompt sentence for natural language notification generation. The server constructs a new text template that incorporates the validated optimal meeting time, agenda information, and participant information. For example, the server generates a second prompt sentence such as:
“Please generate a polite notification message to inform participants about the following meeting. Date and time: Oct. 15, 2023 at 3:00 PM. Agenda: project progress report. Participants: A, B, and C. The message should clearly state the meeting time and agenda and request that participants prepare their status updates.”

The server tokenizes the second prompt sentence and inputs the tokens to the same or a different generative AI model configured for text generation with parameters such as temperature and maximum output length. The model performs a forward pass similar to that described above and produces a sequence of tokens representing the notification message. The server decodes the token sequence into a human-readable natural language notification message and applies post-processing, such as trimming whitespace, ensuring that mandatory meeting details are present, and optionally inserting a standardized subject line.

The server uses a communication unit to transmit the natural language notification message to the meeting participants. The server maps each participant to one or more communication channels, such as an email channel or an instant messaging channel, and constructs protocol-specific message payloads. For email channels, the server creates message headers, including destination addresses and subject fields, and formats the body using text or markup. For messaging channels, the server formats a payload that specifies the destination identifier and message content. The server transmits each payload using corresponding network protocols and libraries, such as an email transfer protocol library or a messaging service interface, and records the responses from external communication services.

The server records transmission result information in a database system. The server represents each transmission event as a record containing a participant identifier, a channel identifier, a timestamp, a status flag indicating success or failure, and an error code or message if available. The server aggregates these records into an overall status object associated with a given meeting notification and stores the status object in the database. The server periodically or on demand retrieves the stored transmission result information when the terminal requests it.

The terminal acquires transmission result information by issuing a status query to the server and displays the status information to the user. The terminal parses the structured status information and updates the user interface to show, for each participant, whether the notification was successfully sent. The user can visually confirm delivery failures and, if necessary, correct contact information through the input interface of the terminal. The server and the terminal thereby cooperate to provide a closed-loop notification workflow with explicit, machine-readable status tracking.

In one variation, the server uses past meeting information and user priority information to influence both the candidate meeting time computation and the generation of the prompt sentences. The server maintains a historical meeting repository containing records of previous meetings, including times, durations, attendance rates, and user roles. The server also maintains priority information per user, such as a numerical importance score or a role category. The server uses these data to adjust the scoring function for candidate meeting times so that times favored by high-priority users or empirically associated with high attendance rates receive higher scores. The server encodes such constraints into the first prompt sentence, for example by adding a phrase such as:
“When selecting the optimal meeting time, prioritize time slots that are convenient for participants with higher priority and that historically have higher attendance for similar meetings.”

The server thereby guides the generative AI model to consider not only raw availability but also derived technical criteria based on structured data, improving both accuracy and suitability of the selected meeting time.

In another variation, the server deploys multiple generative AI models specialized for different functions. The server may use a smaller, latency-optimized model for selecting the optimal meeting time and a larger, quality-optimized model for producing the natural language notification message. The server dynamically selects which model to invoke based on system load conditions or user-specified quality requirements. This model selection reduces average response time and network usage while preserving text quality where needed. The server implements a system-level scheduler that monitors response times and error rates and adjusts model choices or sampling parameters to keep overall processing within target bounds, thereby improving computational efficiency and system stability.

From a technical perspective, the described architecture improves computer technology in several ways. The server performs constraint-aware transformation of schedule data into prompt sentences in a structured and repeatable manner. This transformation uses deterministic algorithms for interval computation, ranking, and verification, which reduce the search space presented to the generative AI model. As a result, the generative component operates over a constrained, pre-filtered set of options, reducing computational overhead compared with brute-force or unconstrained generation, and reducing network traffic when external model services are used.

The server further improves data management by maintaining schedule information, candidate times, optimal times, and transmission result information in normalized data structures and persistent storage. These structures enable efficient queries, such as incremental updates or targeted re-notifications to failed recipients, without recomputing entire schedules. Because the server records machine-readable transmission results, the terminal can programmatically retrieve and display status information, enabling rapid feedback and reducing repeated communication attempts that would otherwise consume network and processing resources.

The system is not limited to automating a human workflow but introduces processing sequences and data flows that are not conventionally performed manually. A human operator cannot readily perform large-scale interval computations across many calendars, maintain historical statistics, encode multi-parameter optimization constraints into textual instructions, and repeatedly query a generative model within response time constraints. The server, however, implements these operations using specific algorithms and data structures that tightly integrate deterministic schedule analysis and neural text generation. This integration yields technical effects such as reduced latency in meeting coordination, increased reliability of notification delivery, decreased error rates in schedule interpretation, and improved utilization of communication bandwidth.

In yet another embodiment, the server uses a training procedure for the generative AI model tailored to meeting scheduling and notification. The server, or an associated training system, collects training data comprising pairs of prompt sentences and desired outputs, such as optimal meeting time selections or example notification messages. The training system defines a loss function, for example a cross-entropy loss between predicted tokens and target tokens, and updates model parameters using an optimization algorithm such as stochastic gradient descent or an adaptive gradient method. The training system may apply data augmentation techniques such as paraphrasing, random perturbation of time expressions, and reordering of participant lists to improve model robustness to input variations. As the model parameters converge, the model becomes better at interpreting constraint-rich prompt sentences and producing outputs that align with the system's scheduling logic. This training approach improves the technical performance of the generative AI model for the specific scheduling domain and thus enhances the efficiency and accuracy of the server at run time.

In a further embodiment, the server implements explicit rule-based post-processing following the generative AI output. For the first prompt sentence, the server compares the model-proposed meeting time against the computed candidate intervals and rejects outputs that do not match any interval within a tolerance window. For the second prompt sentence, the server enforces inclusion of specific tokens or phrases representing the meeting date and time, for example by scanning the output and, if necessary, injecting or correcting such information based on the structured schedule data. These rule-based checks and corrections, applied at machine speed and scale, reduce logical inconsistencies and prevent propagation of incorrect times into notifications, thereby improving system accuracy beyond naive text generation.

The described embodiments can be realized on a variety of hardware and software platforms. The server may be implemented on a physical server, a virtual machine, or a container environment, and may host the generative AI model locally or via an external service. The terminal may be a general-purpose computing device, a specialized workstation, or a mobile device, and may communicate with the server over wired or wireless networks. The generative AI model may be replaced or supplemented by other models or algorithms, such as rule-based text generators or hybrid systems combining symbolic reasoning with neural networks, without departing from the overall concept of constructing and using prompt sentences based on structured schedule data.

Through these concrete configurations and operations, the server, terminal, and generative AI model collectively provide a technically grounded system that transforms raw schedule information into optimized meeting times and accurate, tracked notifications. The integration of deterministic schedule analysis, domain-trained generative modeling, structured data management, and communication control yields measurable improvements in processing speed, accuracy, and resource utilization, thereby improving the functioning of the computer system itself.

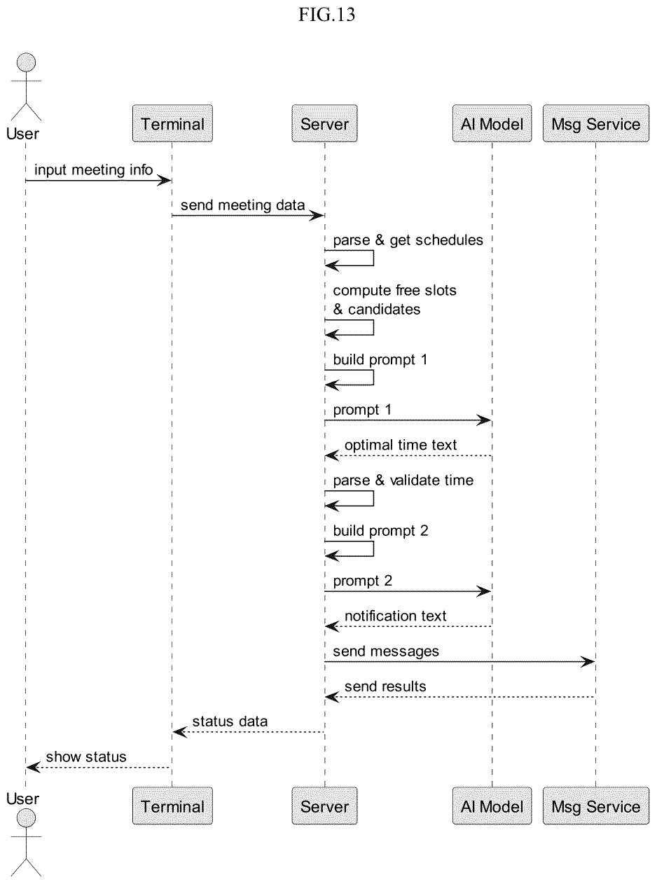

The following describes the processing flow using FIG. 13.
Step 1:

The user operates the terminal to open a meeting information input screen and enters meeting information.

The terminal displays input fields for date and time, agenda, and participants, and receives text and selection inputs from the user.

The input of this step is raw user actions (keystrokes, taps, selections), and the output is a structured internal representation of the meeting information, such as a set of fields for date-time, agenda text, and participant identifiers.

The terminal converts the raw input events into normalized text strings, validates formats (for example, checks for valid date-time format and non-empty participant list), and stores the normalized values in memory as a structured data object.
Step 2:

The terminal generates a meeting information payload and transmits it to the server.

The input of this step is the structured meeting information object generated in Step 1, and the output is an HTTPS request containing a serialized representation of the meeting information.

The terminal serializes the structured data into a message format, attaches metadata such as authentication tokens and content type, and sends the message via a communication interface over a network to a predefined server endpoint.
Step 3:

The server receives and parses the meeting information from the terminal.

The input of this step is the HTTPS request payload containing serialized meeting information, and the output is an internal server-side data structure that represents the meeting information in a machine-readable format.

The server validates the request, deserializes the payload using parsing routines, checks for required fields, and constructs an in-memory representation such as an object with attributes for schedule information, agenda, and participants.
Step 4:

The server retrieves and aggregates schedule information for participants.

The input of this step is the parsed meeting information, including participant identifiers, and the output is a set of schedule records representing existing appointments for each participant.

The server queries storage that contains participants'schedule data, merges results for all specified participants, and loads the data into memory as lists of time intervals representing reserved time slots.
Step 5:

The server computes available time periods for each participant and combined available intervals.

The input of this step is the schedule records from Step 4 and any configuration parameters such as working hours, and the output is one or more available time intervals for each participant and combined intervals across participants.

The server performs interval subtraction between working-time ranges and reserved time slots, merges overlapping free intervals, and then intersects these intervals across participants to obtain multi-participant availability windows.
Step 6:

The server selects candidate meeting times from the available intervals.

The input of this step is the set of available time intervals from Step 5, and the output is a list of discrete candidate meeting times with start and end timestamps.

The server subdivides available intervals into discrete time slots using a configured time granularity, filters slots by constraints such as minimum duration or allowed time-of-day, and assigns each slot a data record containing timing and associated participants.
Step 7:

The server ranks candidate meeting times and selects a subset for generative processing.

The input of this step is the list of candidate meeting times and optional historical and priority data, and the output is an ordered subset of candidate meeting times with scores.

The server computes a score for each candidate using a scoring function that may consider number of participants, user priorities, and historical attendance, sorts candidates by score, and selects top-ranked candidates as input candidates for a generative AI model.
Step 8:

The server constructs a first prompt sentence for an optimal meeting time selection.

The input of this step is the selected candidate meeting times and the original meeting information, and the output is a first prompt sentence expressed as a text string.

The server embeds data values such as date-time ranges and participant names into a textual template, concatenates fixed instructional phrases with dynamic content, and generates structured natural language instructions to guide the generative AI model toward choosing one optimal meeting time.
Step 9:

The server sends the first prompt sentence to a generative AI model and obtains a proposed optimal meeting time.

The input of this step is the first prompt sentence from Step 8, and the output is a generated text sequence containing at least one proposed optimal meeting time.

The server tokenizes the prompt sentence, forwards the tokens and generation parameters to the generative AI model, triggers a forward pass of the model, and receives a sequence of output tokens, which the server decodes into text representing the model's choice and optional justification.
Step 10:

The server extracts and validates the optimal meeting time from the generative output.

The input of this step is the generated text from Step 9, and the output is a validated optimal meeting time expressed as structured date-time data.

The server applies pattern matching and parsing rules to identify date and time expressions in the generated text, converts them into timestamp representations, and compares them with the candidate meeting times to ensure that the proposed time lies within valid intervals, adjusting or rejecting invalid suggestions as necessary.
Step 11:

The server constructs a second prompt sentence for a natural language notification message.

The input of this step is the validated optimal meeting time and the original meeting information, and the output is a second prompt sentence as a text string.

The server populates a notification template with the selected time, agenda, and participant information, and composes explicit instructions asking the generative AI model to generate a clear and polite message suitable for notifying participants about the meeting details.
Step 12:

The server sends the second prompt sentence to a generative AI model and obtains a natural language notification message.

The input of this step is the second prompt sentence from Step 11, and the output is a generated notification message in natural language.

The server tokenizes the second prompt, calls the generative AI model with specified generation parameters, receives output tokens, decodes the tokens into text, and produces a message that contains the meeting date and time, agenda, and any requested phrases such as preparation requests.
Step 13:

The server post-processes the generated notification message.

The input of this step is the raw notification text generated in Step 12, and the output is a finalized notification message ready for transmission.

The server trims unnecessary whitespace, ensures that required meeting details appear in the message by cross-checking with structured data, corrects any formatting issues, and, if needed, prepends a standardized subject or header based on the meeting type.
Step 14:

The server prepares channel-specific transmission payloads for each participant.

The input of this step is the finalized notification message and the list of participants with associated contact information, and the output is a set of channel-specific payloads such as email messages or messaging requests.

The server maps each participant to one or more communication channels, constructs formatted messages including recipient addresses and content, and associates each payload with identifiers for tracking purposes.
Step 15:

The server transmits the notification messages via communication channels.

The input of this step is the set of transmission payloads from Step 14, and the output is a set of transmission responses from external communication services.

The server issues protocol commands or API calls to external mail and messaging systems, sends each payload, waits for responses containing success indicators or error codes, and temporarily stores these responses in memory or persistent storage.
Step 16:

The server records transmission result information and aggregates status data.

The input of this step is the transmission responses obtained in Step 15, and the output is a structured set of transmission result records and an aggregated status object for the meeting notification.

The server creates or updates records indicating, for each participant and channel, whether the message was successfully delivered, the time of the attempt, and any error information, and computes summary statistics such as counts of successful and failed transmissions.
Step 17:

The terminal requests transmission status information from the server.

The input of this step is a user action at the terminal, such as selecting a status view for a particular meeting, and the output is an HTTPS status request sent to the server.

The terminal packages an identifier for the meeting notification into a status query, transmits the query via the communication interface, and waits for the server's response to render the latest delivery status.
Step 18:

The server responds to the status request with structured transmission result information.

The input of this step is the status request from the terminal and the stored transmission result records from Step 16, and the output is a response message containing structured status data.

The server retrieves relevant records from storage, assembles them into a response object listing per-participant status and error details, serializes the object, and sends it back to the terminal over the network.
Step 19:

The terminal displays the transmission status to the user.

The input of this step is the structured status response from Step 18, and the output is a visual presentation of delivery status on the terminal's display.

The terminal parses the response, maps status values to visual indicators such as success or failure icons, updates the user interface to show results for each participant, and allows the user to identify recipients for whom delivery failed and to decide whether to correct information or resend notifications.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

In large-scale collaboration environments, computing systems are increasingly used to coordinate schedules, host remote sessions, and evaluate collaborative activities such as meetings or events. Conventional scheduling systems typically acquire calendar entries from user devices and execute deterministic algorithms on a processor to compute common free time. These systems then present candidate time slots directly to users. Such architectures exhibit several technical problems.

First, conventional systems require the processor to execute complex, rule-based scheduling logic that is difficult to adapt to heterogeneous constraints, such as varying priorities, historical participation patterns, or dynamic availability, without significantly increasing processing complexity. As a result, the central processing unit is subjected to heavy computation for each scheduling task, which degrades scalability and responsiveness of the scheduling service when the number of users and events increases.

Second, traditional systems handle scheduling and notification generation as independent processes. The processor computes a time slot and separately formats a fixed template notification. This separation prevents the system from generating context-aware messages that flexibly incorporate meeting metrics, user preferences, and historical behavior. Consequently, the communication layer cannot be optimized in an integrated manner with the scheduling layer, and the processor cannot efficiently exploit natural-language generation capabilities to reduce application-side processing.

Third, existing meeting support systems often record raw logs or simple counters, but they do not integrate multi-modal analysis of audio, image, and text streams on the server side to derive participation status information and emotional state information in a unified manner. Instead, they either ignore such information or require multiple disjoint subsystems. This leads to fragmented data processing pipelines, redundant data transfers, and increased latency when constructing analytics dashboards. Moreover, the processor typically executes separate, ad-hoc modules to generate evaluation reports, which do not leverage generative models that can synthesize complex improvement proposals from structured metrics.

Fourth, when sentiment or emotional state during a collaborative session is considered, conventional systems generally apply static sentiment analysis on text logs only. They do not continuously aggregate heterogeneous feature values from audio signals and image signals, such as speaking-time patterns and facial expression changes, into higher-level metrics that can be reused programmatically. As a result, improvements rely on manual interpretation by users rather than on automated, machine-generated evaluation, and the processor cannot efficiently transform low-level feature streams into actionable optimization instructions.

Accordingly, there is a need for an improved computer-implemented system in which a processor coordinates (i) acquisition and analysis of schedule information, (ii) construction of prompt sentences for a generative AI model, (iii) collection and fusion of multi-modal participation and emotion metrics during meetings or activities, and (iv) generation of evaluation information and improvement proposals, in a single integrated pipeline. Such a system should reduce the complexity of rule-based scheduling code executed on the processor, offload composition of complex natural-language outputs to a generative AI model through machine-readable prompt sentences, and provide a technically improved way to generate and visualize evaluation and optimization information. By doing so, the system can improve the operation of the computer itself, in terms of scalability, modularity of processing, reduction of application logic, and enhanced usability of analytics, rather than merely automating a human organizational task.

The specific processing by the specific processing unit 290 of the data processing device 12 in Application Example 2 is realized by the following means.

The present invention provides a server comprising a processor configured to acquire schedule information from information processing apparatuses of users via a communication network; analyze the acquired schedule information as time information to identify free time intervals for a plurality of entities; construct meeting candidate information including the identified free time intervals and historical activity information as structured text information; generate a first prompt sentence that instructs a generative AI model to select an optimal meeting date and time based on the meeting candidate information; input the first prompt sentence to the generative AI model and obtain, from the generative AI model, an optimal meeting date and time candidate expressed as natural language information; generate notification information including the optimal meeting date and time candidate and transmit the notification information to the information processing apparatuses of the users; collect, during execution of a meeting or other activity associated with the optimal meeting date and time candidate, audio information, image information, and character information from the information processing apparatuses; compute, from the collected audio information, image information, and character information, participation status information and emotional state information for entities participating in the meeting or other activity; generate evaluation information of the meeting or other activity based on the participation status information and the emotional state information; generate a second prompt sentence including the evaluation information as analysis prompt information to cause the generative AI model to generate improvement proposal information related to the meeting or other activity; obtain, from the generative AI model, the improvement proposal information expressed as natural language information in response to the second prompt sentence; and construct visualization information that includes at least part of the evaluation information and at least part of the improvement proposal information and provide the visualization information to the information processing apparatuses of the users. This enables the processor to offload complex, context-dependent scheduling and report-generation logic to a generative AI model through machine-readable prompt sentences, to unify schedule analysis with multi-modal participation and emotion analysis in a single server-side pipeline, and thereby to improve the operation of the computer system by reducing application-layer complexity, enhancing scalability of scheduling and evaluation processes, and providing richer, automatically synthesized feedback for optimizing collaborative activities.

The term “processor” refers to a hardware or virtual computation unit, such as a central processing unit or an execution core of a computing platform, that executes program instructions to perform data acquisition, analysis, generation, and control operations described in the present disclosure.

The term “information processing apparatus” refers to an electronic device having at least a processor, a memory, and a communication interface, such as a terminal, client device, or user device, that is capable of sending schedule information and receiving notification information or visualization information.

The term “schedule information” refers to time-related data associated with activities of an entity, including but not limited to start times, end times, dates, durations, and identifiers of activities, which are used by the processor to determine availability and to construct meeting candidate information.

The term “time information” refers to data elements representing temporal attributes, such as timestamps, time intervals, and time ranges, that allow the processor to interpret and compare occurrences in time.

The term “free time interval” refers to a continuous time range during which a corresponding entity does not have any registered activity in the schedule information, and that is identified by the processor as a candidate period for arranging a meeting or other activity.

The term “entity” refers to a participant or unit considered in scheduling or evaluation, including a person, a group, an organization, or another logical participant whose schedule information or behavior is processed by the system.

The term “historical activity information” refers to previously recorded data related to past activities, such as past meeting times, attendance records, participation patterns, or preferences, which the processor uses in combination with free time intervals when constructing meeting candidate information.

The term “meeting candidate information” refers to structured data, generated by the processor, that includes free time intervals and optionally historical activity information or constraints, and that is used as a basis for generating a prompt sentence to request selection of an optimal meeting date and time.

The term “text information” refers to data represented as a sequence of characters or symbols, including natural language text or structured strings, that can be processed by the processor and input to a generative AI model.

The term “prompt sentence” refers to text information constructed by the processor that encodes instructions, context, and parameters, and that is input to a generative AI model to cause the generative AI model to generate natural language information or other output relevant to scheduling, evaluation, or improvement proposals.

The term “generative AI model” refers to a trained information processing model, such as a large-scale language model, that receives a prompt sentence as input and outputs generated content, including natural language information such as an optimal meeting date and time candidate, evaluation text, or improvement proposal text.

The term “optimal meeting date and time candidate” refers to a proposed date and time or time interval for a meeting or other activity, generated or selected based on meeting candidate information by the generative AI model, and obtained by the processor as natural language information.

The term “notification information” refers to data generated by the processor that conveys at least the optimal meeting date and time candidate or related guidance, and that is formatted for transmission to and display by an information processing apparatus of a user.

The term “communication network” refers to a wired or wireless data transmission infrastructure, including local networks and wide-area networks, that enables the server and information processing apparatuses to exchange schedule information, notification information, and other data.

The term “audio information” refers to digital data representing sound signals, including speech signals captured by microphones during execution of a meeting or other activity, which are processed by the processor for participation and emotion analysis.

The term “image information” refers to digital data representing visual signals, including still images or video frames captured by cameras during execution of a meeting or other activity, which are processed by the processor for participation and emotion analysis.

The term “character information” refers to text-based data generated during a meeting or other activity, including chat messages, transcribed speech text, or entered notes, which the processor uses to analyze participation status and emotional state.

The term “participation status information” refers to metrics computed by the processor that quantify how entities participate in a meeting or other activity, including metrics such as speaking time, participation rate, join and leave times, and number of interventions.

The term “emotional state information” refers to data computed by the processor that represents inferred emotional conditions of entities during a meeting or other activity, derived from audio information, image information, and character information, and including attributes such as sentiment scores and emotion categories.

The term “evaluation information” refers to data generated by the processor that assesses performance or quality of a meeting or other activity, based at least on participation status information and emotional state information, and that may include ratings, classifications, or summary metrics.

The term “analysis prompt sentence” refers to a particular type of prompt sentence that includes evaluation information or other analytical data and that is provided by the processor to the generative AI model to cause generation of improvement proposal information or evaluative natural language output.

The term “improvement proposal information” refers to natural language content generated by the generative AI model in response to an analysis prompt sentence, which describes recommended changes, adjustments, or enhancements to future meetings or activities.

The term “visualization information” refers to data prepared by the processor in a form suitable for graphical or textual presentation on an information processing apparatus, including charts, diagrams, and annotated text, that incorporates evaluation information and improvement proposal information.

The term “meeting guidance information” refers to notification information that provides instructions or details related to a planned meeting, including but not limited to date, time, location or access information, and contextual description, and that may be generated using natural language information output from the generative AI model.

The term “activity guidance information” refers to notification information that provides instructions or details related to an activity other than a meeting, including scheduling and contextual guidance, and that may similarly use natural language information output from the generative AI model.

The term “communication session” refers to a logical or physical channel established for exchanging information between multiple parties, such as an online meeting session or remote communication link, and is identified by session identification information in the notification information.

The term “identification information of a communication session” refers to data, such as a session identifier or code, that uniquely specifies a particular communication session used to join or manage a meeting or other interactive event.

The term “connection location information” refers to data indicating how to connect to or access a communication session or resource, including network addresses, resource locators, or access paths that are included in notification information for use by an information processing apparatus.

In one embodiment, a server cooperates with one or more terminals used by users to implement the claimed system. The server includes at least one processor, a main memory, a nonvolatile storage device, and a communication interface connected to a communication network. The terminal includes a processor, a memory, a display, input devices such as a keyboard and a pointing device or touch panel, and optionally a microphone and a camera. The server executes a scheduling and evaluation program stored in the storage device, and the terminal executes a client program that interacts with the server.

The server uses an operating system such as a general-purpose server operating system and executes application software implemented, for example, in a high-level language. The server accesses a database management system such as a relational database system to read and write schedule information, meeting logs, and evaluation results. The terminal uses an operating system such as a mobile operating system or a desktop operating system and executes a browser or native application to present user interfaces.

The server acquires schedule information from information processing apparatuses of users. The terminal transmits schedule information using a calendar application or a scheduling client that communicates with the server through an application programming interface over a communication network. The server stores the acquired schedule information in tables of the database. Each schedule record includes at least a user identifier, an activity identifier, a start time, an end time, a date, and optionally metadata such as activity type or priority. The server normalizes all timestamps to a canonical time zone and stores them in a time-indexed structure, for example a table with clustered indexes on user identifier and time range, to enable efficient querying of overlapping intervals.

The server analyzes the schedule information as time information to identify free time intervals. The server loads a set of schedule records for selected users from the database into memory as a time-interval data structure. In one embodiment, the server represents busy intervals for each user as a sorted list of half-open intervals [start, end). The server defines a working-hours interval for each day, such as [09:00, 18:00], and computes free intervals by subtracting all busy intervals from the working-hours interval using an interval subtraction algorithm. The server then intersects the free intervals across multiple users to compute common free time intervals. The server may store the resulting free intervals as records in a candidate table, each record including a set of participant identifiers, a date, a start time, an end time, and a confidence score initialized to a default value.

The server constructs meeting candidate information including the identified free time intervals and historical activity information as structured text. For historical activity information, the server queries past meeting records, attendance logs, and, when available, prior evaluation results. The server aggregates statistics such as historical attendance rate per time-of-day, average delay to meeting start, and historical sentiment scores. The server attaches these statistics to each free interval record. The server then produces a text representation of each candidate, including the free time interval and associated historical statistics, in a structured natural language or semi-structured textual format.

The server generates a prompt sentence to instruct a generative AI model to select an optimal meeting date and time. The server assembles the structured candidate information into a prompt sentence that includes explicit instructions and data. For example, the server generates a prompt sentence such as:
“Using the following candidate time slots and historical statistics, select the best meeting time and briefly explain the reason. Candidates: (1) Monday 10:00-11:00, attendance history high, sentiment generally positive; (2) Tuesday 15:00-16:00, attendance medium, sentiment neutral; (3) Wednesday 17:00-18: 00, attendance low, sentiment slightly negative.”

The server constructs the prompt sentence to follow a consistent format so that the response parsing can be automated. The server may specify constraints in the prompt sentence, such as “Avoid early morning before 9:00 and late evening after 18:00” or “Prefer time slots with historically higher attendance.”

The server inputs the prompt sentence to a generative AI model through an external model-serving interface. The server uses a communication client to transmit a request including the prompt sentence and additional parameters such as maximum output length and sampling parameters. In one embodiment, the generative AI model is a transformer-based neural network with multiple attention layers, trained on a large corpus of natural language data and optionally fine-tuned on scheduling and meeting logs. The server receives the response in the form of natural-language output from the generative AI model. The server parses the response using pattern matching and natural language parsing to extract a proposed meeting date and time, and optionally a justification.

The server validates the extracted optimal meeting date and time candidate against the previously computed free time intervals. If the proposed time does not fall entirely within a computed free interval, the server may discard the suggestion and either select the next best candidate or regenerate a prompt sentence. By constraining the final selection to free intervals already computed by the server, the system avoids inconsistent scheduling and reduces invalid proposals.

The server generates notification information including the optimal meeting date and time candidate and transmits the notification information to the terminals. The server composes message bodies using the natural-language text returned by the generative AI model or, if desired, combines that text with additional structured information. For example, the server generates a message body such as:
“The optimal time for the next project meeting is Tuesday from 15:00 to 16:00. This time has historically shown good attendance and stable sentiment. Please confirm your participation.”

The server may embed communication session identification information or connection location information, such as a meeting URL created by a conferencing system, into the notification information. The server then transmits the notification information through email, push notification, or messaging protocols. The terminal receives the notification, displays it to the user, and allows the user to respond.

The server collects audio information, image information, and character information obtained during execution of a meeting. In one embodiment, the terminal participates in an online meeting using conferencing software. The terminal captures audio through the microphone and video through the camera. The conferencing platform or a local module sends audio streams and, optionally, low-resolution video frames or derived facial feature vectors to the server. In a variant, the server subscribes to meeting logs and retrieves chat messages and transcribed speech from a speech recognition service.

The server computes participation status information using the collected data. The server segments audio streams into intervals, identifies active speakers using energy thresholds and spectral features, and counts the total speaking time for each participant. The server computes participation rate as a ratio of speaking time or interventions to meeting duration. The server stores these metrics in a relational table keyed by meeting identifier and participant identifier.

The server computes emotional state information using audio information, image information, and character information. The server extracts acoustic features such as pitch contours, intensity, and spectral centroid from audio segments using digital signal processing techniques. The server applies a trained neural network for emotion classification, for example a recurrent or convolutional architecture that takes sequences of acoustic features and outputs probabilities for emotion categories such as positive, neutral, and negative. The server processes image information or facial feature vectors using a convolutional neural network trained on facial expressions to infer basic emotions. The server processes character information, including chat messages and transcribed speech, using a language model or sentiment classifier to produce sentiment scores. The server fuses these emotion estimates via a weighted combination or a second-level classifier to produce final emotional state information per participant and per time segment.

The server generates evaluation information of the meeting based on the participation status information and the emotional state information. The server computes composite indices such as speaking-time balance, engagement index, and average sentiment. The server labels the meeting with a performance category according to predetermined rules, for example “effective” if participation is balanced and sentiment is positive, or “ineffective” if participation is highly skewed and sentiment is negative. The server stores the evaluation information as structured records.

The server generates an analysis prompt sentence including the evaluation information to cause the generative AI model to generate improvement proposal information. The server constructs a prompt sentence describing the metrics and including explicit instructions. For example, the server generates a prompt sentence such as:
“Here are the metrics for the last meeting: Participant A spoke for 25 minutes, Participant B for 3 minutes, Participant C for 2 minutes; overall sentiment was slightly negative in the middle and neutral at the end; engagement index was low. Evaluate the efficiency of this meeting and propose three concrete changes to improve balance and mood for the next meeting.”

The server inputs this analysis prompt sentence into the generative AI model, receives a natural-language report and recommendations, and stores them as improvement proposal information. The server then constructs visualization information, such as charts and annotated text descriptions, that includes at least the evaluation information and the improvement proposal information. The server provides the visualization information to the terminals via a web dashboard or embedded in notification messages.

In another embodiment, the server performs multi-modal emotion analysis using a neural network architecture that explicitly includes late fusion of features. The server uses a feature extractor network for audio, a feature extractor for video, and a separate text encoder, and combines intermediate representations in a fully-connected fusion layer. The server trains this architecture using a supervised learning method on labeled multi-modal emotion datasets. During training, the server uses a cross-entropy loss function on emotion labels, and updates weights by stochastic gradient descent or a variant such as Adam. The server may use data augmentation such as time-shifting audio segments, random cropping of image regions, or synonym replacement in text to improve robustness. Because this architecture jointly optimizes audio, video, and text encoders for the specific task of meeting emotion assessment, the system produces more accurate and stable emotional state information than approaches relying only on one modality.

In yet another embodiment, the server refines the schedule analysis using a heuristic optimization algorithm rather than relying solely on a direct intersection of free intervals. The server assigns a cost value to each candidate time interval, taking into account not only the number of available participants, but also historical attendance statistics, typical working times in different time zones, and previous evaluation scores of meetings held in similar time windows. The server runs a search algorithm, such as a greedy search or a local search, over the space of candidate intervals to minimize expected cost. The server then uses the generative AI model not to compute the time directly from scratch, but to explain and refine the selected candidate and produce human-readable justifications and potential alternatives. This division of labor allows the processor to execute a deterministic and efficient optimization procedure while delegating natural-language generation to the generative AI model.

The server thus improves the functioning of the computer system in several technical aspects. By representing schedule information and free intervals in indexed data structures and using intersection algorithms, the server reduces the number of candidate time slots that must be considered, thereby reducing computation time and memory usage for large user populations. By using a generative AI model through carefully structured prompt sentences, the server avoids embedding complex natural-language generation logic into application code, leading to smaller and more maintainable codebases and lower CPU utilization for text generation tasks. By fusing multi-modal features in a trained neural network for emotion estimation, the server reduces classification errors compared with single-modality analysis, which in turn improves the reliability of automated evaluation and subsequent optimization. By integrating evaluation and improvement proposal generation into the same server-side pipeline, the server eliminates repeated data export/import cycles, reducing communication load between subsystems.

The server does not merely automate a human organizer's workflow. The server introduces non-conventional processing steps and data structures within the computer, such as structured candidate representations tailored for generative models, multi-modal feature fusion networks trained with specific loss functions, and prompt construction algorithms that encode internal metrics for automatic analysis by the generative AI model. These technical features change how schedule data, meeting logs, and emotion signals are processed inside the computer to achieve improved performance metrics such as faster schedule computation, better emotion estimation accuracy, and reduced message generation complexity.

The terminal in these embodiments displays visualization information and notification information, receives user input such as confirmations or declines, and optionally captures audio and image data for the server. The user interacts with the terminal to register schedule information, to view proposed meeting times and evaluation reports, and to adjust behavior based on improvement proposals. In some variations, the terminal can perform preliminary processing, such as face detection or voice activity detection, and send only compressed or feature-level data to the server, which further reduces network bandwidth consumption and accelerates central analysis.

In another variation, the server deploys multiple generative AI models with different configurations, such as separate models tuned for scheduling guidance and performance evaluation, and selects an appropriate model based on content of the prompt sentence. The server may also include fallback mechanisms where, if a generative response cannot be parsed or fails internal validation, the server reverts to a deterministic message-generation routine. By combining model-based generation with deterministic validation and optimization, the system maintains both flexibility and robustness.

In still another embodiment, the server uses the evaluation information and improvement proposal information to update internal parameters or thresholds in the scheduling or analysis modules. For example, if repeated recommendations suggest avoiding late-afternoon meetings due to consistently negative sentiment and low engagement, the server adjusts internal cost functions or rule weights so that future free interval selection de-prioritizes late-afternoon slots. In this way, the system implements a feedback mechanism that improves its scheduling and evaluation behavior over time, not only from direct human input but also from patterns extracted via the generative AI model.

Through these embodiments, the server, terminal, and user cooperate to implement a concrete, computer-centered system that processes schedule information, multi-modal meeting data, and evaluation metrics using specific data structures, algorithms, and neural network models. The system thereby achieves technical effects of improved processing speed, higher emotion estimation accuracy, reduced communication and code complexity, and enhanced usability of the computer-generated outputs.

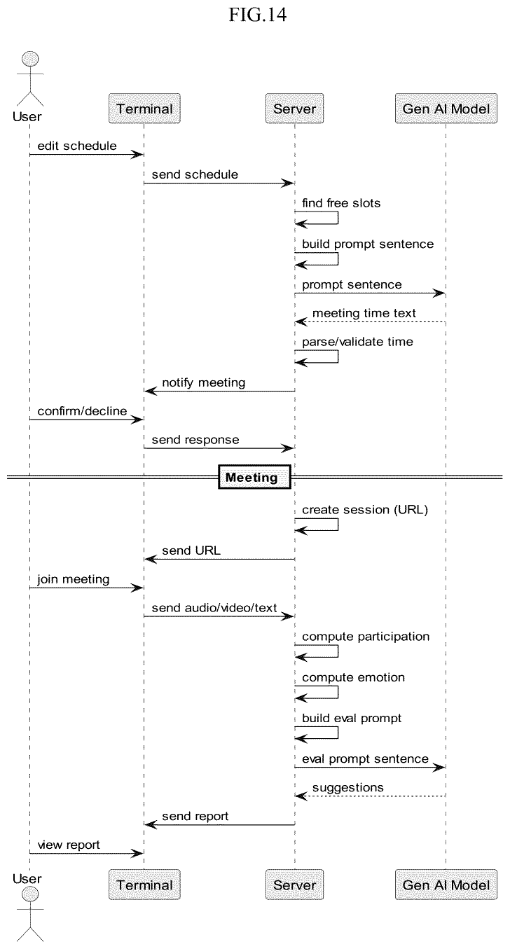

The following describes the processing flow using FIG. 14.
Step 1:

Server acquires schedule information.

Server receives, as input, schedule data from terminals or external calendar services, including user identifiers, activity identifiers, start times, and end times. Server authenticates using stored credentials, sends API requests over a network, and parses responses into internal records. Server performs data conversion to a common time zone and stores normalized schedule records in a database as rows with indexed fields for user and time. Server outputs a consistent set of schedule entries ready for time-interval analysis.
Step 2:

Server identifies free time intervals.

Server loads, as input, schedule records for selected users from the database. Server groups records by user and sorts busy intervals by start time. Server executes interval-subtraction operations against predefined working hours for each day, computing gaps between busy intervals. Server intersects resulting free intervals across users by scanning sorted lists and computing overlaps. Server outputs a list of free time intervals, each defined by a date, start time, end time, and associated user set.
Step 3:

Server attaches historical activity information.

Server uses, as input, the free time intervals from Step 2 and historical meeting records stored in the database. Server aggregates statistics such as past attendance rates and average sentiment for each time-of-day window by scanning historical logs and applying grouping and averaging operations. Server maps these statistics onto the free time intervals based on matching weekday and time range. Server outputs enriched candidate records that contain both free time intervals and historical activity metrics.
Step 4:

Server constructs meeting candidate information text.

Server takes, as input, the enriched candidate records from Step 3. Server formats each record into structured text, including interval labels and numeric statistics, by concatenating strings and converting numerical values to human-readable phrases. Server may order candidates by preliminary scores and include them in a single composite text block. Server outputs a meeting candidate information text that explicitly lists candidate time slots and related metrics.
Step 5:

Server generates a scheduling prompt sentence.

Server receives, as input, the meeting candidate information text from Step 4 and optional constraints configured by an administrator or user (for example, disallowed hours). Server combines a fixed instruction template with the candidate information and constraints, using string templates and insertion of variable fields. For example, server constructs a prompt sentence such as: “Using the following candidate time slots and statistics, select the best meeting time and explain briefly.” Server outputs a complete prompt sentence designed for a generative AI model.
Step 6:

Server sends the scheduling prompt sentence to a generative AI model.

Server uses, as input, the prompt sentence from Step 5 and generation parameters (for example, maximum length, temperature). Server encodes these into a request payload and transmits the payload to a model endpoint via a network protocol. Server waits for the response and receives natural-language output text. Server outputs the raw model response as a candidate explanation and proposed meeting time.
Step 7:

Server parses the generative AI model output.

Server takes, as input, the natural-language response from Step 6. Server applies text-processing operations, such as regular expression matching and date-time parsing, to locate explicit time expressions and dates. Server converts identified expressions into structured data with date, start time, and end time fields. Server validates that this structured time lies within one of the original free time intervals by comparing start and end values. Server outputs a validated optimal meeting date and time candidate; if parsing fails, server outputs an error state.
Step 8:

Server generates and sends scheduling notification information.

Server uses, as input, the validated optimal meeting date and time candidate and the model's textual explanation. Server composes message bodies by formatting subject, greeting, time description, and explanation using templates. Server attaches meeting identifiers or connection location information, such as a meeting URL created separately via a conferencing API. Server sends these messages via email, push, or messaging APIs to terminals, and outputs a delivery log indicating success or failure for each destination.
Step 9:

Terminal receives and displays scheduling notifications.

Terminal takes, as input, notification messages delivered from the server. Terminal invokes an email client, messaging client, or push notification handler to parse payload fields such as title, body, and link. Terminal displays the notification on a screen as a list entry, banner, or pop-up. Terminal stores a local record of the notification and outputs a user-readable visual representation; optionally, terminal sends a read acknowledgment back to the server.
Step 10:

User confirms or declines the proposed meeting.

User reads, as input, the notification content rendered by the terminal. User decides whether to accept, decline, or propose an alternative time. User selects a response option by tapping a button or clicking a link. Terminal packages the user's decision with identifiers (user ID, meeting ID) and sends it to the server. Server receives the decision and outputs updated participation status records in the database.
Step 11:

Server creates an online communication session.

Server uses, as input, the confirmed optimal meeting date and time and the list of participants. Server sends a request to a conferencing platform API, including scheduled start time, duration, topic, and host credentials. Server receives, as output, communication session identification information and connection location information, such as a session ID and join URL. Server stores these identifiers in a meeting table linked to the meeting record and outputs updated meeting metadata.
Step 12:

Server notifies participants of the communication session details.

Server takes, as input, meeting metadata including the session ID and join URL from Step 11. Server embeds this information into messages, for example: “Meeting URL: [link]. Start time: [date/time].” Server formats the final body text using natural-language content from the generative AI model or a fixed template. Server transmits these details to all participant terminals via communication channels. Server outputs a record of sent invitations, including timestamps and delivery status.
Step 13:

Terminal connects the user to the meeting.

Terminal receives, as input, the invitation message with the join URL. User taps the join link, and terminal launches the conferencing client application or a browser. Terminal passes the join URL to the conferencing client through an inter-application communication mechanism. Conferencing client establishes an audio and video connection using the terminal's microphone and camera. Terminal outputs a live session connection state and streams media traffic.
Step 14:

Terminal captures multi-modal meeting data.

Terminal uses, as input, sensor data from the microphone and camera during the meeting. Terminal encodes audio into digital frames and captures video frames or extracts face-region crops. Terminal may perform initial preprocessing such as voice activity detection or face detection to reduce data volume. Terminal sends processed audio and image data, with timestamps and participant identifiers where available, to the server. Terminal outputs data packets representing meeting media streams.
Step 15:

Server collects and stores meeting logs and character information.

Server takes, as input, media streams and control logs from the conferencing system or terminal, including join and leave events, chat messages, and transcription data if available. Server writes join/leave events into attendance tables, and stores chat and speech transcripts as text records indexed by timestamp and participant. Server outputs persistent logs that will be used for participation and emotion analysis.
Step 16:

Server computes participation status information.

Server uses, as input, the attendance logs, audio activity markers, and text contributions recorded in Step 15. Server calculates speaking time per participant by summing durations of audio segments where each participant is detected as the active speaker. Server computes participation rate as speaking time divided by total meeting duration, and counts interventions based on distinct speech segments or chat messages. Server stores these metrics in a structured table. Server outputs participation status information such as speaking-time values, participation rates, and intervention counts.
Step 17:

Server extracts audio features for emotion analysis.

Server takes, as input, audio frames associated with each participant. Server applies digital signal processing operations, such as windowing and fast Fourier transforms, to compute spectral features. Server calculates higher-level descriptors such as pitch contours, energy, formant estimates, and temporal derivatives. Server normalizes features per participant to reduce inter-speaker variation. Server outputs feature vectors ordered by time for each participant.
Step 18:

Server extracts image and text features for emotion analysis.

Server uses, as input, face-region images and textual data (transcripts and chat messages). Server applies a face detection model to locate facial landmarks, then extracts normalized face patches. Server passes these patches through a convolutional feature extractor to obtain face-embedding vectors. Server encodes text segments using a language embedding model, producing numeric vectors representing semantic content. Server outputs aligned feature sequences: facial feature vectors and text embeddings indexed by timestamps.
Step 19:

Server estimates emotional state information via multi-modal fusion.

Server takes, as input, audio feature vectors, facial feature vectors, and text embeddings from Steps 17 and 18. Server feeds each modality into a corresponding sub-network, such as a recurrent layer for audio, a convolutional or residual layer for images, and a transformer or recurrent layer for text. Server concatenates intermediate representations and passes them to a fusion layer that outputs probabilities for discrete emotion categories and continuous sentiment scores. Server assigns the highest-probability emotion as the dominant state for each time segment, and aggregates over the meeting to compute overall emotion metrics per participant. Server outputs emotional state information including time-series emotion labels and average sentiment scores.
Step 20:

Server generates evaluation information of the meeting.

Server uses, as input, participation status information from Step 16 and emotional state information from Step 19. Server computes composite indices, such as a balance index derived from the variance of speaking times, and an engagement index based on participation rate and emotion intensity. Server applies predefined rules or threshold comparisons to classify the meeting into categories such as “highly effective” or “needs improvement.” Server assembles a structured summary containing raw metrics and categorical evaluations. Server outputs evaluation information ready for reporting and for use in prompt construction.
Step 21:

Server builds an analysis prompt sentence for meeting evaluation.

Server takes, as input, the evaluation information from Step 20. Server converts numeric metrics into descriptive phrases, for example, “Participant A spoke for 25 minutes, Participant B for 3 minutes” or “average sentiment was slightly negative in the middle.” Server inserts these descriptions into an instruction template that asks for assessment and suggestions. For instance, server generates a prompt sentence such as: “Here are the metrics for the last meeting: [metrics]. Evaluate the efficiency and propose three improvements.” Server outputs an analysis prompt sentence suitable for input to a generative AI model.
Step 22:

Server obtains improvement proposal information from the generative AI model.

Server uses, as input, the analysis prompt sentence from Step 21 and generation parameters. Server sends a request containing the prompt sentence to the generative AI model's endpoint and receives a natural-language response that includes an evaluation narrative and recommended changes. Server may perform basic validation and segmentation of the response, separating numbered proposals or bullet points. Server outputs improvement proposal information as text segments linked to the corresponding meeting.
Step 23:

Server constructs visualization information.

Server takes, as input, evaluation information from Step 20 and improvement proposal information from Step 22. Server uses charting routines to generate visual elements such as bar charts of speaking time and line graphs of sentiment over time, mapping metric values to axes and colors. Server combines these graphical elements with textual summaries and proposals into a dashboard layout, encoded in a markup language or a structured format. Server outputs visualization information that can be rendered by terminals as a web page or in-application view.
Step 24:

Terminal displays evaluation and improvement visualization to the user.

Terminal receives, as input, visualization information transmitted by the server. Terminal interprets layout instructions and chart specifications, rendering graphs and text on the display using a graphical toolkit or browser engine. Terminal provides interactive elements such as tooltips or filters to allow the user to inspect details. Terminal outputs an on-screen representation that lets the user understand meeting performance and suggested improvements.
Step 25:

User adjusts future behavior or settings based on server output.

User reviews, as input, the evaluation visualization and natural-language improvement proposals presented by the terminal. User decides whether to modify future scheduling preferences, adjust meeting formats, or reassign responsibilities. User changes configuration options in the client application or calendar settings, such as disallowing late-afternoon meetings or requiring shorter durations. Terminal sends updated preference data to the server, and server updates internal parameters or cost weights accordingly, outputting a new configuration state that influences subsequent scheduling and analysis.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

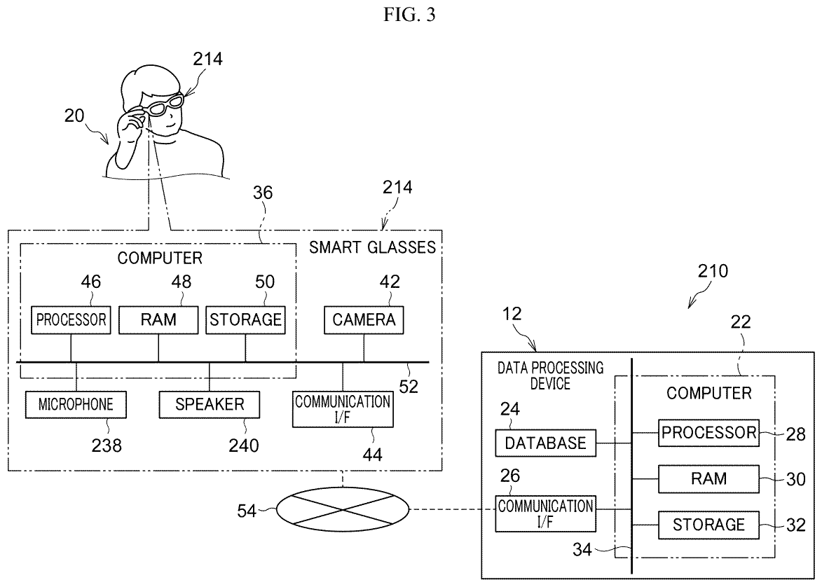

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

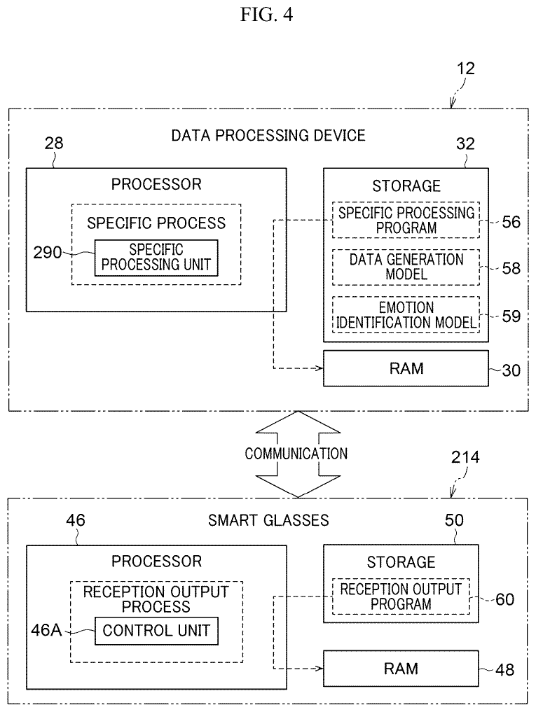

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

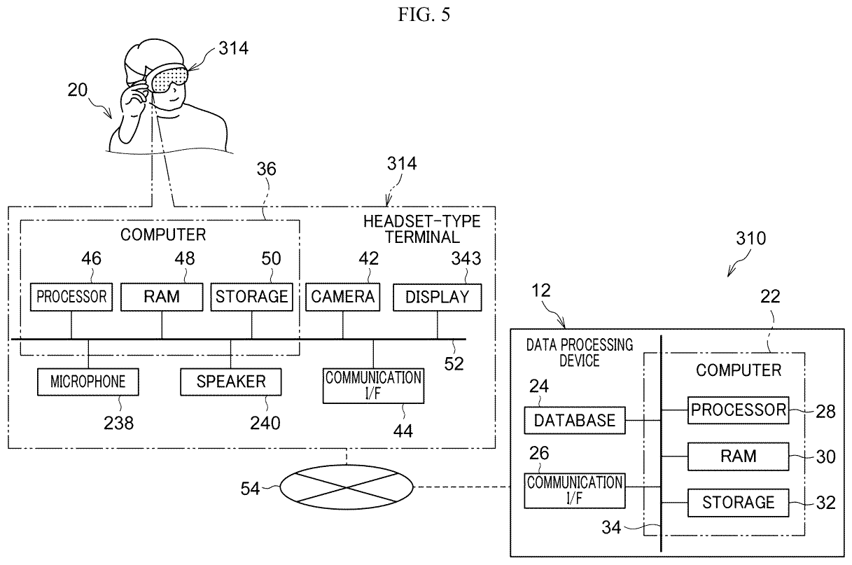

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

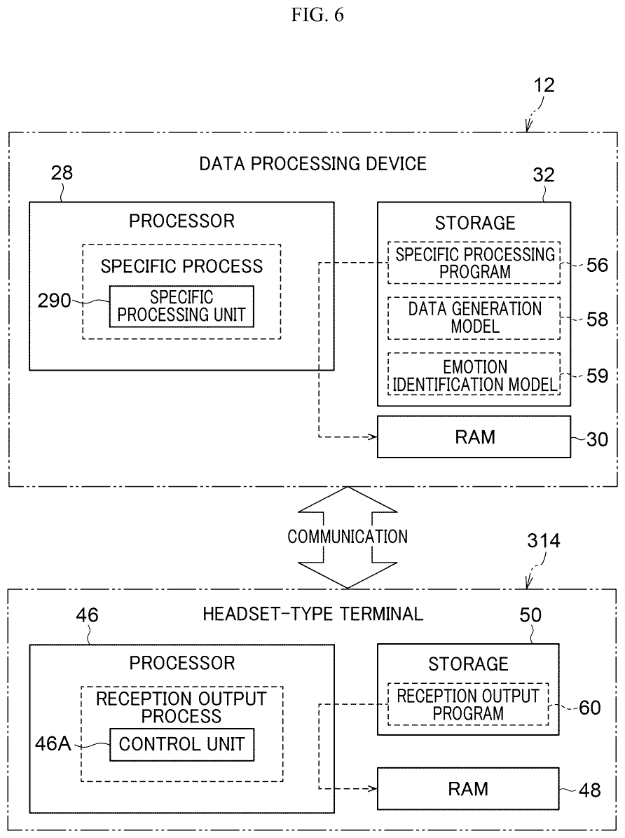

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

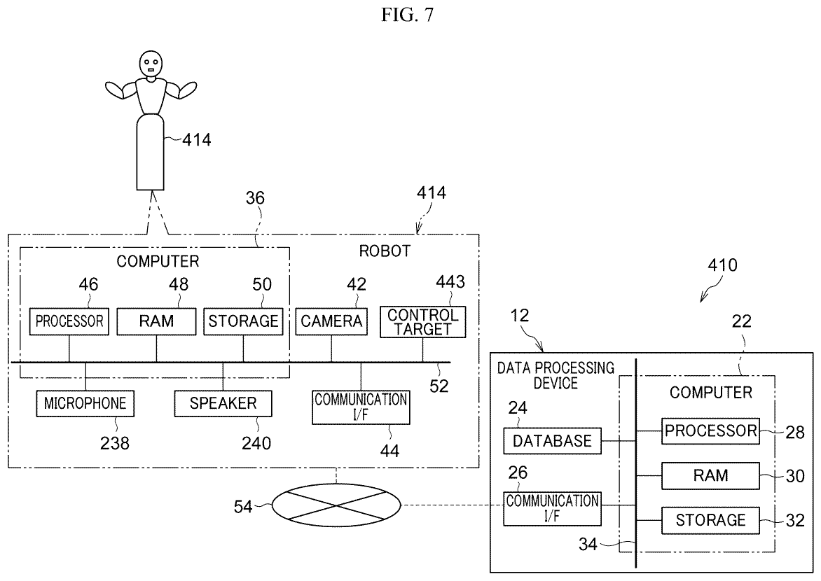

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

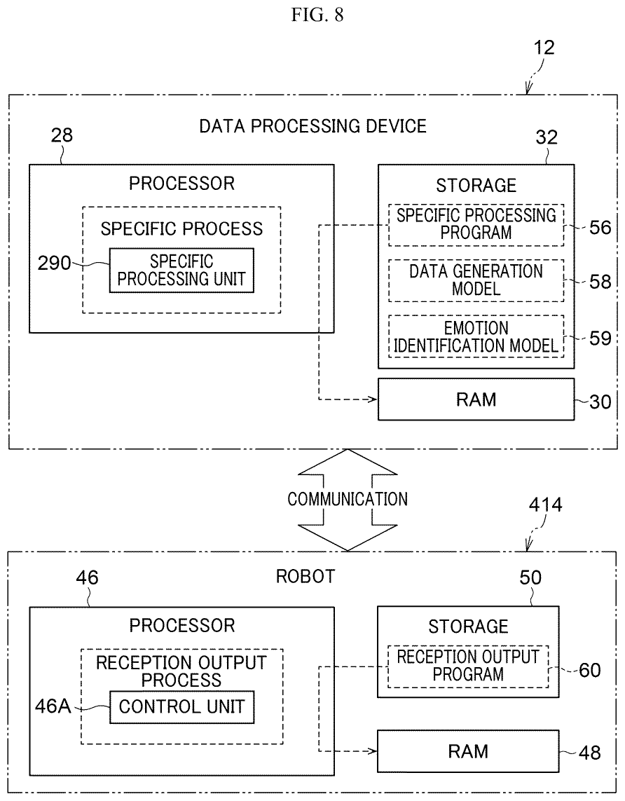

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

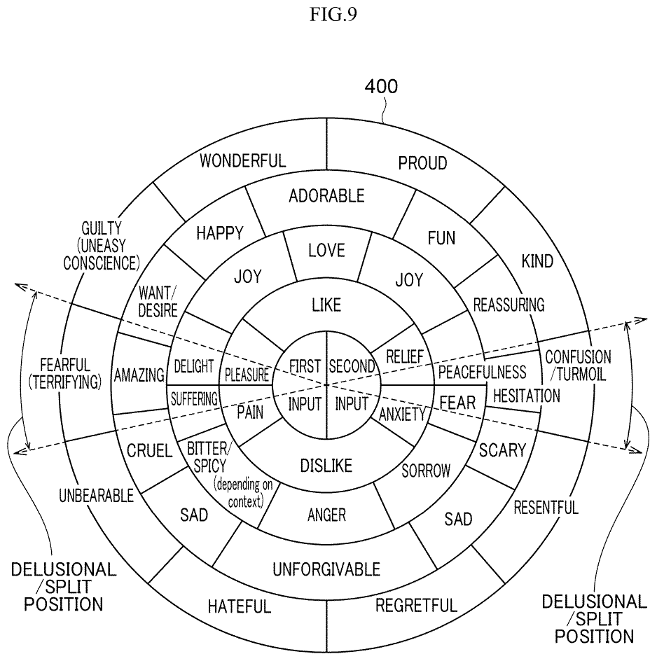

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

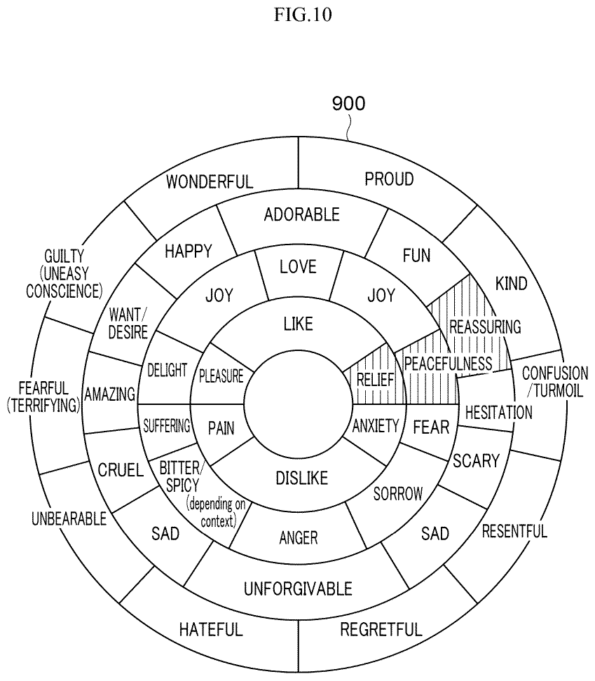

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### (Supplementary 1)

A system comprising a processor,
wherein the processor is configured to
acquire schedule-related information from an external information processing apparatus via a communication network and store the acquired schedule-related information as time information data,
convert the schedule-related information into tabular data by using time-series data processing software, calculate occupied time intervals for each usage entity,
computationally specify free time intervals for each usage entity by excluding the occupied time intervals from a predetermined operation time range, and computationally extract common free time intervals among a plurality of usage entities,
generate structured information including the common free time intervals and condition information, convert the structured information into a natural language description, and
generate a prompt sentence including an instruction for a generative AI model to perform selection processing of candidate meeting dates and times and including an instruction defining an output format of the generative AI model,
input the prompt sentence to the generative AI model, acquire a candidate meeting date and time output from the generative AI model, and verify whether the candidate meeting date and time is included in the common free time intervals to thereby confirm the candidate meeting date and time, and
generate meeting information based on the confirmed candidate meeting date and time, transmit the meeting information as notification information to a terminal, and, in response to a response from the terminal, cause the external information processing apparatus to execute a schedule registration process.

### (Supplementary 2)

The system according to supplementary 1,
wherein the processor is configured to
represent time information as numerical sequences by using numerical calculation software when computationally extracting the common free time intervals, perform set operations or interval operations on the numerical sequences to narrow down candidate time intervals, and include, in the structured information, only those candidate time intervals whose lengths are equal to or greater than a predetermined meeting duration.

### (Supplementary 3)

The system according to supplementary 1,
wherein the processor is configured to
add past meeting history information, preference information for each usage entity, and time-slot priority information to the structured information when generating the prompt sentence to be input to the generative AI model, instruct the generative AI model to evaluate the candidate meeting dates and times based on the added information and to output reason information together with the candidate meeting dates and times, and select a final meeting date and time from among a plurality of candidate meeting dates and times based on the reason information.

### Application Example 1

### (Supplementary 1)

A system comprising a processor,
wherein the processor is configured to
acquire operation information regarding a plurality of target apparatuses,
analyze the acquired operation information and maintenance history information to specify operation states of the target apparatuses,
calculate candidate time periods for maintenance work of the target apparatuses on the basis of the specified operation states and acquired schedule information,
generate a prompt sentence that instructs a generative AI model to select an optimal execution date and time for the maintenance work on the basis of the calculated candidate time periods and the operation information and the maintenance history information, and
input the prompt sentence to the generative AI model,
compare a proposal result of the optimal execution date and time for the maintenance work output from the generative AI model with the schedule information to detect a temporal conflict, and adjust the optimal execution date and time in accordance with the detected temporal conflict, and
convert the adjusted execution date and time for the maintenance work into information for visual display and output the information for visual display to a terminal.

### (Supplementary 2)

The system according to supplementary 1,
wherein the processor is configured to
provide the operation information, the maintenance history information, past maintenance result information, and past adjusted execution date and time information as learning information to the generative AI model so as to improve estimation accuracy in selecting the optimal execution date and time for the maintenance work based on the prompt sentence.

### (Supplementary 3)

The system according to supplementary 1,
wherein the processor is configured to
acquire, as the schedule information, operation schedule information regarding the plurality of target apparatuses and work schedule information regarding users, and include, in the prompt sentence to the generative AI model, instructions specifying a maximum number of target apparatuses to be stopped simultaneously in a same time period and simultaneous stop prohibition conditions between particular target apparatuses.

### Example 2

### (Supplementary 1)

A system comprising a processor,
wherein the processor is configured to
acquire, from a user terminal, meeting information including schedule information of at least one participant,
analyze the acquired meeting information to identify available time periods of the at least one participant and, based on the available time periods, specify at least one candidate meeting time,
generate a first prompt sentence, based on the meeting information and the at least one candidate meeting time, for instructing a generative AI model to select an optimal meeting time,
input the first prompt sentence into the generative AI model and acquire the optimal meeting time selected by the generative AI model,
generate a second prompt sentence, based on the optimal meeting time and the meeting information, for causing the generative AI model to generate a natural language notification message to be provided to meeting participants,
input the second prompt sentence into the generative AI model and acquire the natural language notification message generated by the generative AI model,
transmit the natural language notification message to the meeting participants via a communication unit,
and acquire and record transmission result information regarding transmission of the natural language notification message to the meeting participants, and provide the transmission result information to the user terminal.

### (Supplementary 2)

The system according to supplementary 1,
wherein the processor is configured to
identify, based on the acquired meeting information, an available time period for each of a plurality of users, and include the available time periods for the plurality of users as constraint conditions in the first prompt sentence to be input to the generative AI model for selection of the optimal meeting time.

### (Supplementary 3)

The system according to supplementary 1,
wherein the processor is configured to
cause the generative AI model, when generating the optimal meeting time based on the first prompt sentence and generating the natural language notification message based on the second prompt sentence, to adjust the optimal meeting time and content of the natural language notification message in consideration of past meeting information and priority information of the users.

### Application Example 2

### (Supplementary 1)

A system comprising a processor,
wherein the processor is configured to
acquire schedule information from an information processing apparatus of a user,
analyze the schedule information as time information and identify free time intervals of a plurality of entities,
construct meeting candidate information including the free time intervals and historical activity information as text information, and generate a prompt sentence that instructs a generative AI model to select an optimal meeting date and time based on the meeting candidate information,
input the prompt sentence to the generative AI model and acquire, from the generative AI model, an optimal meeting date and time candidate as natural language information,
generate notification information including the optimal meeting date and time candidate and transmit the notification information to the information processing apparatus of the user via a communication network,
collect audio information, image information, and character information obtained during execution of a meeting, and calculate participation status information and emotional state information of the meeting,
generate evaluation information of the meeting based on the participation status information and the emotional state information, and generate an analysis prompt sentence including the evaluation information to cause the generative AI model to generate improvement proposal information, and
construct visualization information including the evaluation information and the improvement proposal information and provide the visualization information to the information processing apparatus of the user.

### (Supplementary 2)

The system according to supplementary 1,
wherein the processor is configured to
extract feature values from the audio information and the image information obtained during execution of the meeting, calculate, based on the feature values, speaking time information, participation rate information, and emotional change information for each entity, and include the speaking time information, the participation rate information, and
the emotional change information in the analysis prompt sentence to be input to the generative AI model so that the generative AI model generates, as natural language information, an efficiency evaluation of the meeting and contents of improvement of the meeting.

### (Supplementary 3)

The system according to supplementary 1,
wherein the processor is configured to
use the natural language information output from the generative AI model as a body text of meeting guidance information or activity guidance information when generating the notification information, and include, in the body text, identification information of a communication session for the meeting or connection location information, and transmit the notification information including the body text to the information processing apparatus of the user

What is claimed is:

1. A system comprising:
circuitry configured to:
acquire, via a communication interface coupled to a packet-switched network, schedule data from a plurality of external information processing apparatuses, and store the schedule data as time information records in an information storage device;
convert the schedule data into tabular data using a time-series data processing operation, compute occupied time intervals for each entity by merging overlapping event records, specify free time intervals for each entity by subtracting the occupied time intervals from a predetermined operation time range, and compute common free time intervals among a plurality of entities by performing interval intersection operations on the free time intervals;
generate structured constraint data comprising the common free time intervals and condition parameters, convert the structured constraint data into a natural language description, and construct a constrained instruction sequence comprising the natural language description and an output format specification for a generative neural network model comprising a transformer-based architecture;
input the constrained instruction sequence into the generative neural network model to acquire a candidate time allocation, verify that the candidate time allocation is included within the common free time intervals by comparing timestamp values, and upon successful verification, designate the candidate time allocation as a confirmed time allocation; and
generate coordination event data based on the confirmed time allocation, transmit notification data to terminal devices via the communication interface, and in response to confirmation data received from the terminal devices, transmit registration requests to the external information processing apparatuses to create schedule entries.

2. The system according to claim 1, wherein the circuitry is further configured to:
represent the free time intervals as numerical sequences, perform set intersection operations on the numerical sequences using a numerical computation operation to extract the common free time intervals, and filter the common free time intervals to retain only intervals having a duration equal to or greater than a predetermined minimum duration.

3. The system according to claim 2, wherein the circuitry is further configured to:
discretize the free time intervals into fixed-length time slots, represent availability of each entity as a binary occupancy vector, and compute the common free time intervals by performing bitwise logical AND operations across the binary occupancy vectors of the plurality of entities.

4. The system according to claim 1, wherein the circuitry is further configured to:
normalize all timestamp values in the schedule data to a common reference time zone, convert the normalized timestamp values to integer representations indicating elapsed time units from a fixed epoch, and perform the interval intersection operations on the integer representations.

5. The system according to claim 1, wherein the constrained instruction sequence further comprises:
historical coordination data, preference data for each entity, and time-slot priority data, and the constrained instruction sequence instructs the generative neural network model to evaluate the candidate time allocation based on the historical coordination data and the preference data and to output reason data together with the candidate time allocation.

6. The system according to claim 5, wherein the circuitry is further configured to:
select a confirmed time allocation from a plurality of candidate time allocations output by the generative neural network model based on the reason data and a ranking score computed from the time-slot priority data.

7. The system according to claim 1, wherein the circuitry is further configured to:
when the candidate time allocation is not included within the common free time intervals, construct a correction instruction sequence specifying the verification failure and re-input the correction instruction sequence into the generative neural network model to obtain a revised candidate time allocation, or select a default candidate from the common free time intervals using a deterministic ranking operation.

8. The system according to claim 1, wherein the generative neural network model comprises:
an embedding layer configured to convert input tokens into multidimensional tensor representations, a positional encoding module, a plurality of transformer layers each comprising multi-head self-attention and feed-forward sublayers with layer normalization, and a decoding stage configured to generate a probability distribution over a vocabulary and select output tokens using a sampling strategy.

9. The system according to claim 8, wherein the circuitry is further configured to:
set inference parameters for the generative neural network model comprising a temperature value, a maximum token count, and a stop sequence, and configure the output format specification to require the generative neural network model to produce output in a structured format comprising field delimiters enabling automated parsing of the candidate time allocation.

10. The system according to claim 1, wherein the circuitry is further configured to:
parse a natural language request from the terminal device to extract constraint parameters comprising a date range, a duration, and entity identifiers, and use the extracted constraint parameters to define the predetermined operation time range and to select entities for the interval intersection operations.

11. The system according to claim 1, wherein the circuitry is further configured to:
construct a second constrained instruction sequence based on the confirmed time allocation and entity data, input the second constrained instruction sequence into the generative neural network model to generate natural language notification content, and include the natural language notification content in the notification data transmitted to the terminal devices.

12. The system according to claim 11, wherein the circuitry is further configured to:
apply a post-processing operation to the natural language notification content comprising verifying that required data fields including the confirmed time allocation are present in the notification content, and when a required data field is absent, injecting the missing data field from the structured constraint data.

13. The system according to claim 1, wherein the circuitry is further configured to:
record transmission result data for each notification indicating a success or failure status and a timestamp, aggregate the transmission result data into a status record associated with the coordination event data, and provide the status record to the terminal device upon request.

14. The system according to claim 1, wherein the circuitry is further configured to:
maintain a preference learning model that assigns priority scores to candidate time intervals based on feature vectors comprising day-of-week indicators, time-of-day indicators, and historical acceptance rates, update the priority scores using a machine learning operation based on past acceptance and rejection data, and incorporate the priority scores into the constrained instruction sequence.

15. The system according to claim 1, wherein the circuitry is further configured to:
acquire operation data from a plurality of target apparatuses, compute apparatus state classifications from the operation data, calculate maintenance candidate time periods based on the apparatus state classifications and the schedule data, construct a maintenance instruction sequence for the generative neural network model to select optimal maintenance time allocations, verify the maintenance time allocations against the schedule data for temporal conflicts, and adjust conflicting time allocations based on constraint parameters including a maximum simultaneous apparatus stoppage count.

16. The system according to claim 15, wherein the circuitry is further configured to:
provide the operation data, maintenance history data, and past adjusted time allocation data as training data to update parameters of the generative neural network model to improve accuracy of subsequent maintenance time allocation selections.

17. The system according to claim 11, wherein the coordination event data comprises meeting information, the schedule data comprises calendar entries of meeting participants, the common free time intervals represent shared available time slots among participants, the confirmed time allocation represents an optimal meeting date and time, the notification data comprises meeting invitation messages, and the registration requests create calendar events in external calendar management systems for a meeting scheduling service.

18. A system comprising:
circuitry configured to:
acquire schedule data from a plurality of external information processing apparatuses via a communication interface coupled to a packet-switched network;
compute occupied time intervals and free time intervals for each entity, and compute common free time intervals by interval intersection operations;
construct a constrained instruction sequence comprising the common free time intervals and condition parameters, and input the constrained instruction sequence into a generative neural network model to acquire a candidate time allocation;
verify that the candidate time allocation is within the common free time intervals and designate a confirmed time allocation; and
generate coordination event data and transmit notification data to terminal devices.

19. The system according to claim 18, wherein the circuitry is further configured to:
construct a second constrained instruction sequence based on the confirmed time allocation and input the second constrained instruction sequence into the generative neural network model to generate natural language notification content included in the notification data.

20. A method comprising:
acquiring, by circuitry via a communication interface coupled to a packet-switched network, schedule data from a plurality of external information processing apparatuses, and storing the schedule data as time information records in an information storage device;
converting the schedule data into tabular data, computing occupied time intervals for each entity, specifying free time intervals by subtracting the occupied time intervals from a predetermined operation time range, and computing common free time intervals by performing interval intersection operations;
generating structured constraint data comprising the common free time intervals and condition parameters, converting the structured constraint data into a natural language description, and constructing a constrained instruction sequence comprising the natural language description and an output format specification;
inputting the constrained instruction sequence into a generative neural network model comprising a transformer-based architecture to acquire a candidate time allocation, verifying that the candidate time allocation is within the common free time intervals, and designating the candidate time allocation as a confirmed time allocation; and
generating coordination event data, transmitting notification data to terminal devices, and in response to confirmation data, transmitting registration requests to the external information processing apparatuses.
